(19) United States
(12) Patent Application Publication
(10) Pub. No.: US 2026/0364822 A1
(43) Pub. Date: Nov. 19, 2026

(54) LOCKING MECHANISMS FOR ROTATABLE FINGERS

(71) Applicant: Cryovac, LLC, Charlotte, NC (US)

(72) Inventors: Roger Jeffrey Anderson, Mooresville, NC (US); Stoyanka Dimitrova Kostadinova, Fort Mill, SC (US); Bradley Keith Powell, York, SC (US)

(21) Appl. No.: 19/126,077

(22) PCT Filed: Nov. 1, 2023
(86) PCT No.: PCT/US2023/036580

§ 371 Date: Apr. 30, 2025

Related U.S. Application Data
(60) Provisional application No. 63/422,090, filed on Nov. 3, 2022.

(51) Int. Cl. B25J 15/08; B25J 15/00; B25J 15/10

(52) U.S. Cl. CPC B25J 15/083; B25J 15/0014; B25J 15/10

(57) ABSTRACT

A system includes a frame, an arm, a finger, and a locking mechanism. The arm is movable with respect to the frame in first and second directions. The finger is rotatably coupled to the arm and is capable of rotating between an open position and a holding position. The locking mechanism is coupled to the finger and can be in unlocked and locked configurations. The locking mechanism allows the finger to rotate between the open and holding positions when the locking mechanism is in the unlocked configuration, transition from the unlocked configuration to the locked configuration in response to the finger rotating to the holding position, hold the finger in the holding position when the locking mechanism is in the locked configuration, and transition from the locked configuration to the unlocked configuration in response to movement of the arm with respect to the frame in the second direction.

### BACKGROUND

The present disclosure is in the technical field of holding deformable objects, such as raw meat products. More particularly, the present disclosure is directed to systems and methods of holding raw meat products, such as those lifted from a surface, using a system that includes a locking mechanism that holds a finger of an arm in a holding position and releases the finger from the holding position in response to outward movement of the arm.

Deformable objects can be difficult to move using electromechanical tools. The deformable nature of the objects does not lend itself to being grasped by traditional tools, such as pincers or other end-of-arm tools on robotic arms. These difficulties with grasping deformable objects reduce or eliminate the advantages of reliability and repeatability of electromechanical tools.

The difficulties with moving deformable objects are compounded when the deformable objects are raw meat products, such as raw beef cuts. Raw meat products come in a large range of sizes and a broad range of weights, making it difficult for a single tool to be able to properly move all types of raw meat products. The manner and force of grasping raw meat products can also damage the raw meat products. In addition, any portion of the tool that contacts raw meat products must be capable of proper cleaning to comply with food and safety regulations. This concern makes complex grasping tools challenging for grasping raw meat products.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In a first embodiment, a system includes a frame and an arm movable with respect to the frame in a first direction and in a second direction opposite to the first direction. The system further includes a finger rotatably coupled to the arm. The finger is rotatable with respect to the arm between an open position and a holding position. The system further includes a locking mechanism coupled to the finger. The locking mechanism is configured to selectively be in an unlocked configuration and in a locked configuration. The locking mechanism is configured to allow the finger to rotate between the open position and the holding position when the locking mechanism is in the unlocked configuration, transition from the unlocked configuration to the locked configuration in response to the finger rotating to the holding position, hold the finger in the holding position when the locking mechanism is in the locked configuration, and transition from the locked configuration to the unlocked configuration in response to movement of the arm with respect to the frame in the second direction.

In a second embodiment, the locking mechanism of the first embodiment is a passive locking mechanism.

In a third embodiment, the passive locking mechanism of the second embodiment includes a rod slidably coupled to the arm and a head rotatably coupled to the arm. The rod includes a distal end coupled to the finger and a proximal end configured to engage the head.

In a fourth embodiment, the head of the third embodiment includes a first surface and a second surface. The head and the rod are arranged so that the proximal end of the rod is capable of contacting the first surface when the locking mechanism is in the unlocked configuration and the proximal end of the rod contacts the second surface when the locking mechanism is in the locked configuration.

In a firth embodiment, the passive locking mechanism of the fourth embodiment includes a first biasing mechanism configured to bias the rod toward the head.

In a sixth embodiment, the passive locking mechanism of the fifth embodiment includes a second biasing mechanism configured to rotationally bias the head to the locked configuration with the second surface located above the proximal end of the rod.

In a seventh embodiment, the system of the sixth embodiment is configured such that the head comprises a pawl, the frame comprises a plurality of teeth, and, when the locking mechanism is in the locked configuration and the arm is with respect to the frame in the second direction, the pawl is positioned to engage one of the plurality of teeth to rotate the head against a force of the second biasing mechanism.

In an eighth embodiment, a spacing between each of the plurality of teeth of the seventh embodiment is less than or equal to 0.75 inches (1.91 cm).

In a ninth embodiment, the pawl of any of the seventh to eighth embodiments is rotationally biased with respect to a body of the head.

In a tenth embodiment, the locking mechanism of the first embodiment is an active locking mechanism.

In an eleventh embodiment, the active locking mechanism of the tenth embodiment includes a controller configured to control transition of the locking mechanism from the unlocked configuration to the locked configuration in response to the finger rotating to the holding position and to control the transition of the locking mechanism from the locked configuration to the unlocked configuration in response to movement of the arm with respect to the frame in the second direction.

In a twelfth embodiment, the active locking mechanism of the eleventh embodiment further includes one or more sensor configured to detect rotation of the finger to the holding position and/or movement of the arm with respect to the frame in the second direction.

In a thirteenth embodiment, a system includes a frame and a first pair of opposing arms. The first pair of opposing arms includes a first arm and a second arm. Each of the first and second arms is movable with respect to the frame in an inward direction toward the other of the first and second arms and in an outward direction away from the other of the first and second arms. The system further includes a first finger rotatably coupled to the first arm and a second finger rotatably coupled to the second arm. Each of the first and second fingers is rotatable between an open position and a holding position. The system further includes a first locking mechanism coupled to the first finger and a second locking mechanism coupled to the second finger. Each of the first and second locking mechanisms is configured to selectively be in an unlocked configuration and in a locked configuration. The first locking mechanism is configured to allow the first finger to rotate between the open position and the holding position when the first locking mechanism is in the unlocked configuration, transition from the unlocked configuration to the locked configuration in response to the first finger rotating to the holding position, hold the first finger in the holding position when the locking mechanism is in the locked configuration, and transition from the locked configuration to the unlocked configuration in response to movement of the first arm with respect to the frame in the outward direction. The second locking mechanism is configured to allow the second finger to rotate between the open position and the holding position when the second locking mechanism is in the unlocked configuration, transition from the unlocked configuration to the locked configuration in response to the second finger rotating to the holding position, hold the second finger in the holding position when the locking mechanism is in the locked configuration, and transition from the locked configuration to the unlocked configuration in response to movement of the second arm with respect to the frame in the outward direction.

In a fourteenth embodiment, the first and second arms of the thirteenth embodiment are biased away from each other by a biasing force.

In a fifteenth embodiment, the frame of the fourteenth embodiment is configured to exert a force on the first and second arms to cause the first and second arms to move inward with respect to the frame against the biasing force.

In a sixteenth embodiment, the each of the first and second locking mechanisms of any of the thirteenth to fifteenth embodiments is a passive locking mechanism that includes a rod slidably coupled to one of the first and second arms and head rotatably coupled to the one of the first and second arms. The rod includes a distal end coupled to the finger and a proximal end configured to engage the head. The head comprises a pawl. The frame comprises a plurality of teeth. When the locking mechanisms is in the locked configuration and the arm is with respect to the frame in the second direction, the pawl is positioned to engage one of the plurality of teeth to rotate the head.

In a seventeenth embodiment, the system of any of the thirteenth to sixteenth embodiment further includes a second pair of opposing arms. The second pair of opposing arms includes a third arm and a fourth arm. Each of the third and fourth arms is movable with respect to the frame in an inward direction toward the other of the third and fourth arms and in an outward direction away from the other of the third and fourth arms. The system further includes a third finger rotatably coupled to the third arm and a fourth finger rotatably coupled to the fourth arm, wherein each of the third and fourth fingers is rotatable between an open position and a holding position. The system further includes a third locking mechanism coupled to the third finger and a fourth locking mechanism coupled to the fourth finger, wherein each of the third and fourth locking mechanisms is configured to selectively be in an unlocked configuration and in a locked configuration. The third locking mechanism is configured to allow the third finger to rotate between the open position and the holding position when the third locking mechanism is in the unlocked configuration, transition from the unlocked configuration to the locked configuration in response to the third finger rotating to the holding position, hold the third finger in the holding position when the locking mechanism is in the locked configuration, and transition from the locked configuration to the unlocked configuration in response to movement of the third arm with respect to the frame in the outward direction. The fourth locking mechanism is configured to allow the fourth finger to rotate between the open position and the holding position when the fourth locking mechanism is in the unlocked configuration, transition from the unlocked configuration to the locked configuration in response to the fourth finger rotating to the holding position, hold the fourth finger in the holding position when the locking mechanism is in the locked configuration, and transition from the locked configuration to the unlocked configuration in response to movement of the fourth arm with respect to the frame in the outward direction.

In an eighteenth embodiment, the first pair of opposing arms of the seventeenth embodiment is capable of inward and outward movement independently of inward and outward movement of the second pair of opposing arms.

In a nineteenth embodiment, the system of any of the seventeenth to eighteenth embodiments further includes a third pair of opposing arms. The third pair of opposing arms includes a fifth arm and a sixth arm, and wherein each of the fifth and sixth arms is movable with respect to the frame in an inward direction toward the other of the fifth and sixth arms and in an outward direction away from the other of the fifth and sixth arms. The system further includes a fifth finger rotatably coupled to the fifth arm and a sixth finger rotatably coupled to the sixth arm. Each of the fifth and sixth fingers is rotatable between an open position and a holding position. The system further includes a fifth locking mechanism coupled to the fifth finger and a sixth locking mechanism coupled to the sixth finger. Each of the fifth and sixth locking mechanisms is configured to selectively be in an unlocked configuration and in a locked configuration. The fifth locking mechanism is configured to allow the fifth finger to rotate between the open position and the holding position when the fifth locking mechanism is in the unlocked configuration, transition from the unlocked configuration to the locked configuration in response to the fifth finger rotating to the holding position, hold the fifth finger in the holding position when the locking mechanism is in the locked configuration, and transition from the locked configuration to the unlocked configuration in response to movement of the fifth arm with respect to the frame in the outward direction. The sixth locking mechanism is configured to allow the sixth finger to rotate between the open position and the holding position when the sixth locking mechanism is in the unlocked configuration, transition from the unlocked configuration to the locked configuration in response to the sixth finger rotating to the holding position, hold the sixth finger in the holding position when the locking mechanism is in the locked configuration, and transition from the locked configuration to the unlocked configuration in response to movement of the sixth arm with respect to the frame in the outward direction.

In a twentieth embodiment, each of the first pair of opposing arms, the second pair of opposing arms, and the third pair of opposing arms of the nineteenth embodiment is capable of inward and outward movement independently of the others of the first pair of opposing arms, the second pair of opposing arms, and the third pair of opposing arms.

### BRIEF DESCRIPTION OF THE DRAWING

The foregoing aspects and many of the attendant advantages of the disclosed subject matter will become more readily appreciated as the same become better understood by reference to the following detailed description, when taken in conjunction with the accompanying drawings, wherein:

FIGS. 1A to 1E depict an embodiment of a system 100 for gripping objects;

FIGS. 2A to 2C depict a series of instances of the system shown in FIGS. 1A to 1E inadvertently dropping a deformable object;

FIGS. 3A and 3B depict partial side views of a system that overcomes the inadvertent dropping problem shown in FIGS. 2A to 2C, in accordance with the embodiments described herein:

FIGS. 4A to 4F depict instances of a method of using the system shown in FIGS. 3A and 3B to move a deformable object, in accordance with the embodiments described herein;

FIGS. 5A to 5F depict an embodiment of a system that includes passive locking mechanism and instances of the operation of the passive locking mechanism, in accordance with the embodiments described herein;

FIGS. 6A to 14B depict an embodiment of a system can be used to lift a deformable object from a surface and a method of the system being used to lift a deformable object from a surface, in accordance with the embodiments described herein;

FIGS. 15A to 15D depict instances of another embodiment of a method of using the system shown in FIGS. 3A and 3B to move a deformable object, in accordance with the embodiments described herein;

FIGS. 16A to 16D depict instances of another embodiment of the operation of the passive locking mechanism shown in FIGS. 5A to 5F, in accordance with the embodiments described herein;

FIGS. 17A to 17E depicts instances of an embodiment of the rotational movement of the pawl with respect to the body in the locking mechanism depicted in FIGS. 5A to 5F, in accordance with the embodiments described herein;

FIG. 18 depicts an example embodiment of a system that may be used to implement some or all of the embodiments described herein; and

FIG. 19 depicts a block diagram of an embodiment of a computing device, in accordance with the embodiments described herein.

### DETAILED DESCRIPTION

The present disclosure describes embodiments of locking mechanisms configured to hold a finger of an arm a holding system in a holding position and to release the finger from the holding position in response to outward movement of the arm. This type of locking device allows for simple and effective holding and release of objects by the fingers.

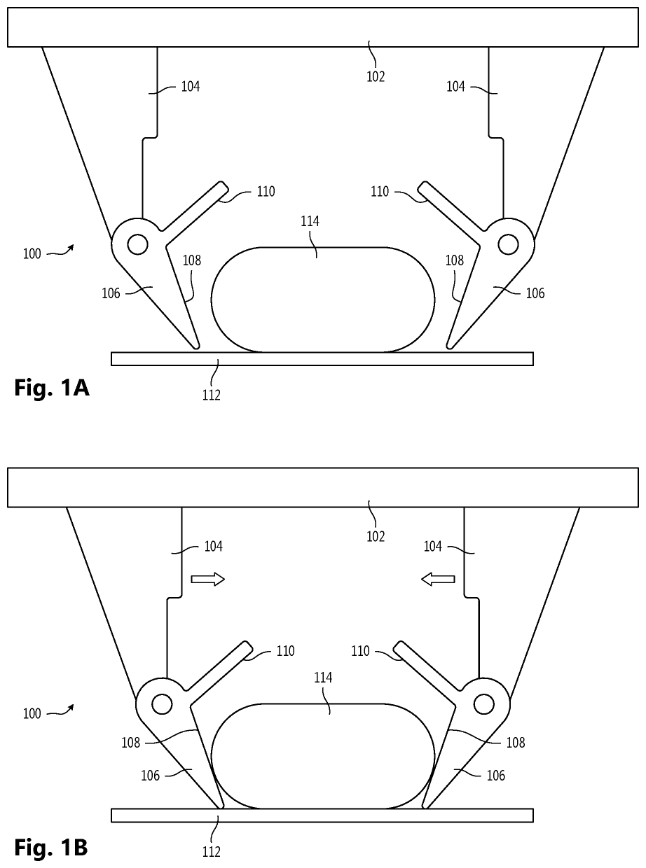

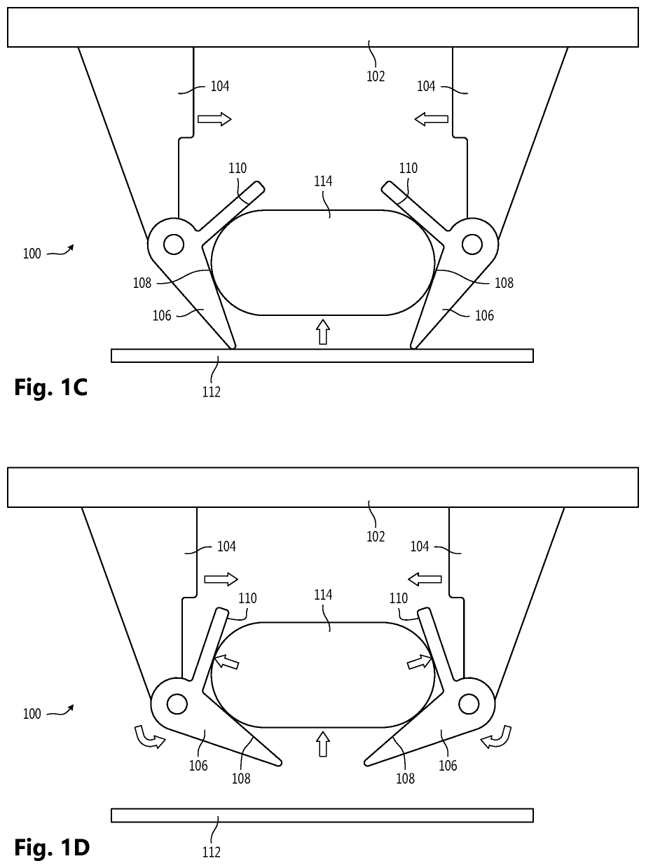

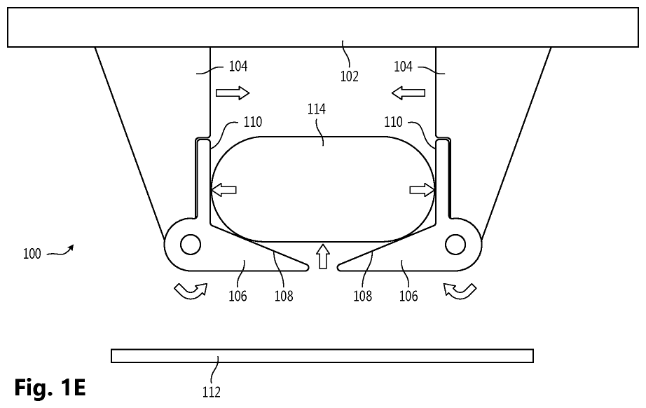

FIGS. 1A and 1B depict an embodiment of a system 100 for gripping objects. In some embodiments, the system 100 can be coupled on the end of a robotic arm as an end-of-arm tool. The system 100 includes a frame 102. The frame 102 can include any type of structure that holds the other elements of the system 100. In some embodiments, the top of the frame 102 is configured to be coupled to the end of a robotic arm and the robotic arm is configured to move the system 100 to pick up, move, and release objects.

The system 100 further includes arms 104 that are coupled to the frame 102. In the depicted example, the arms 104 include a pair of arms that are centered about the center of the frame 102. In some embodiments, the frame 102 includes a driving mechanism configured to move the arms 104, such as motor, a solenoid, a pneumatic actuator, a hydraulic actuator, and the like. In some embodiments, the driving mechanism is configured to move the arms 104 so that the arms 104 remain centered about the frame 102. For example, as the driving mechanism is configured to move both of the arms 104 either toward the center of the frame 102 together or outward from the center of the frame 102 together.

The system 100 also includes fingers 106. In some embodiments, one of the fingers 106 is rotatably coupled to each of the arms 104. In the depicted embodiment, the fingers 106 are configured to rotate passively (i.e., in response to forces applied to the fingers 106) in a range of rotation from the positions shown in FIG. 1A to the positions shown in FIG. 1E. The fingers 106 are configured to hold objects, as is discussed in greater detail below. In the instance shown in FIG. 1A, gravity is the only the force acting on the fingers 106 and the fingers 106 are rotated to the position shown in FIG. 1A by gravity. In the depicted embodiment, each of the fingers 106 includes a first surface 108 and a second surface 110. As discussed in greater detail below, the first and second surfaces 108 and 110 are configured to contact an object and to hold the object.

FIG. 1A also depicts a surface 112 and an object 114 located on the surface 112. In some embodiments, the surface is a static surface (e.g., a table top, a shelf, etc.) or a dynamic surface (e.g., a conveyor belt, a set of rollers, etc.). Each of FIGS. 1A to 1E depicts an instance of an embodiment of a method of the system 100 being used to lift the deformable object 114 from the surface 112. In FIG. 1A, the arms 104 are withdrawn from the sides of the deformable object 114 and the fingers 106 are biased toward the lower rotational position. At the instance depicted in FIG. 1A, neither of the fingers 106 has come into contact with the surface 112. If either or both of the fingers 106 had come into contact with the surface 112, the fingers 106 can rotate. This ability of the fingers 106 to rotate in response to contact with the surface 112 is particularly helpful if the surface 112 is uneven (e.g., not level), is a compliant material (e.g., a rubber conveyor belt), or other similar non-rigid and/or non-level surface. This ability of the fingers 106 to rotate in response to contact with the surface 112 also ensures that the tips of the fingers 106 can remain in contact with the surface and slide underneath the deformable object 114. In FIG. 1B, the arms 104 have been moved inward with respect to the frame 102 until the inclined surfaces 108 have come into contact with the right and left sides of the deformable object 114. In some embodiments, the system 100 includes driving mechanism, such as a fluid power driver operatively coupled in parallel to each of the pairs of opposing arms 104 via a fluid power system and the arms 104 are moved inward by the fluid power driver increasing the pressure in the fluid power system. Although not shown in FIGS. 1A to 1E, each of the pairs of opposing arms in the system 100 can be coupled in parallel to the fluid power driver so that each of the pairs of arms is capable of closing a different distance until the inclined surfaces 108 are all in contact with the sides of the deformable object 114.

From the instance shown in FIG. 1B to the instance shown in FIG. 1C, the driving mechanism has increased the force on the arms 104 inward toward the deformable object 114. Because all of the inclined surfaces 108 were in contact with the deformable object 114 at the instance shown in FIG. 1B, the increase in force to the instance shown in FIG. 1C caused the arms 104 to exert a compressive force on the deformable object 114. The compressive force exerted by the arms 104 on the deformable object 114 causes the deformable object 114 to slide up the inclined surfaces 108 and lift the deformable object 114 off of the surface 112. At the instance shown in FIG. 1C, the deformable object 114 has not yet come into contact with the lateral contact surfaces 110 of the fingers 106.

From the instance shown in FIG. 1C to the instance shown in FIG. 1D, the driving mechanism has increased the force on the arms 104 in the inward direction. The increased force on the arms 114 has caused the sides of the deformable object 114 to come into contact with the lateral contact surfaces 110 of the fingers 106, which results in the deformable object 114 exerting a force on the lateral contact surfaces 110. The force from the deformable object 114 on the lateral contact surfaces 110 has caused the fingers 106 to begin counterrotating until the fingers 106 are in the rotational position shown in FIG. 1D. The counterrotation of the fingers 106 has caused the inclined surfaces 108 to rotate upward and further lift the deformable object 114 away from the surface 112.

From the instance shown in FIG. 1D to the instance shown in FIG. 1E, the driving mechanism has increased the force on the arms 104 in the inward direction. The increased force on the arms 114 has caused the sides of the deformable object 114 to continue exerting a force back on the lateral contact surfaces 110 of the fingers 106. The deformable object 114 exerting a force on the lateral contact surfaces 110 has caused the fingers 106 to continue counterrotating until the fingers 106 are in the higher rotational position shown in FIG. 1E. The counterrotation of the fingers 106 as caused the inclined surfaces 108 to rotate upward and further lift the deformable object 114 away from the surface 112. In some embodiments, the fingers 106 are prevented from counterrotating beyond the higher rotational position due to physical interference with the arms 104.

While the driving mechanism continues exerting a force on the arms 104, the arms 104 continue exerting a force on the deformable object 114. This force from the arms 104 toward the deformable object 114 causes the deformable object 114 to exert a reciprocal force back on the lateral surfaces 110 of the fingers 106. This reciprocal force from the deformable object 114 causes the fingers 106 to remain in the higher rotational position shown in FIG. 1E so that the fingers 106 continue to hold the deformable object 114. In this way, the system 100 can hold the deformable object 114 while the system is moved (e.g., by a robotic arm).

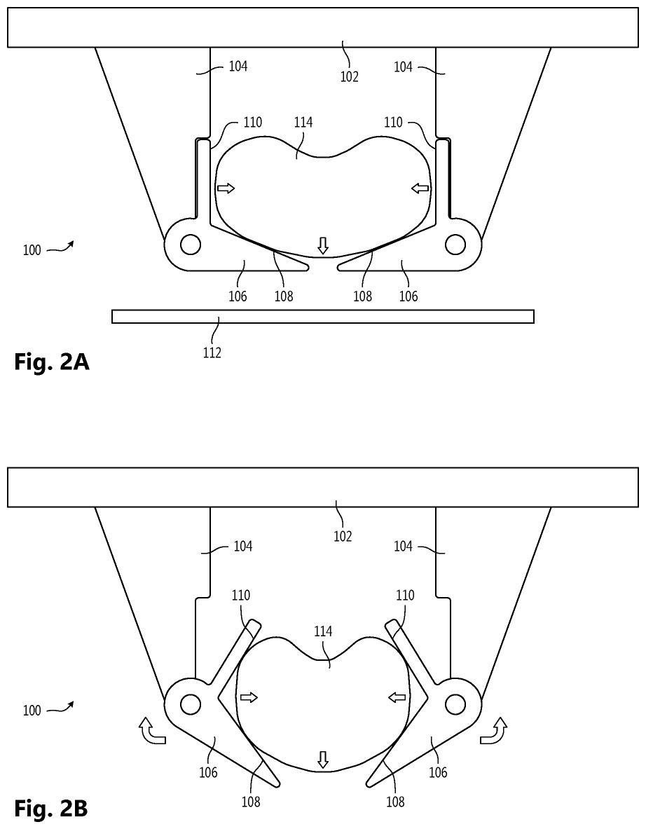

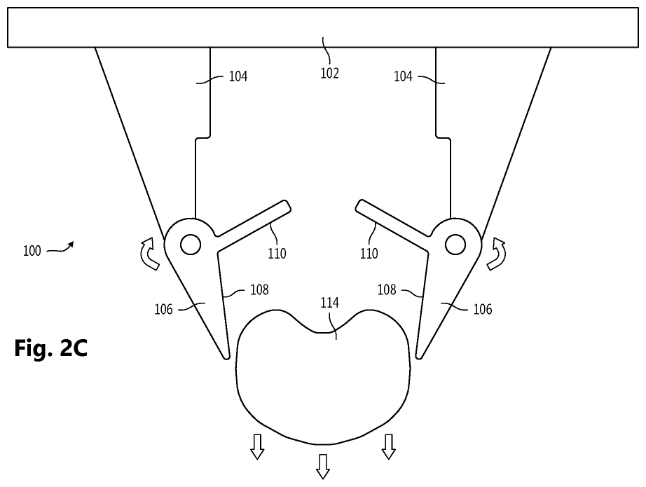

While the system 100 can be an effective tool for holding the deformable object 114, the system 100 can also inadvertently drop the deformable object 114 under some circumstances. Once such circumstance is depicted in the series of events shown in FIGS. 2A to 2C. In FIG. 2A, the deformable object 114 has begun to deform from the shape that it had in FIG. 1E. In particular, the bottom of the deformable object 114 has begun to sag down, which results in the sides of the deformable object to withdraw from the lateral surfaces 110 of the fingers 106. This deformation of the deformable object 114 is possible with particular types of deformable objects, such as pieces of raw, boneless meat. In the depicted embodiment, the arms 104 have not moved inward closer to each other as the deformable object 114 deforms. This may occur under certain circumstances, such as when the arms 104 are already at the further inward location of their range of travel with respect to the frame 102, the driving mechanism does not have a fast enough reaction to push the arms 104 inward to maintain contact with the deformation of the deformable object 114, or other similar circumstances.

FIG. 2B depicts that, after the sides of the deformable object 114 lose contact with the lateral surfaces 110 of the fingers 106 and there is insufficient reaction force on the lateral contact surfaces 110 to resist the moment around the pivot of the fingers 106 caused by the weight of the deformable object 114 on the first surfaces 108, the fingers 106 are free to counterrotate downward. As the fingers 106 counterrotate downward the deformable object 114 can continue to deform. In the depicted embodiment, the bottom of the deformable object 114 moved downward as the sides of the deformable object 114 have moved inward. This deformation of the deformable object 114 and the downward counterrotation of the fingers 106 has allowed the deformable object 114 to begin to fall downward. The weight of the deformable object 114 is also exerting a force on the first surfaces 108 of the fingers 106, which increases the rate at which the fingers are counterrotating downward and allowing the deformable object 114 to fall.

FIG. 2C depicts an instance after the instance shown in FIG. 2B, where the deformable object 114 has dropped to a point where it is no longer in contact with the fingers 106 and the deformable object 114 is freely falling. The fingers 106 have counterrotated to the point where the first surfaces 108 are no longer in contact with the deformable object 114. In some embodiments, the rotational position of the fingers 106 is the lowermost position to which the fingers 106 are capable of rotating. At the point depicted in FIG. 2C, the system 100 has inadvertently dropped the deformable object 114 without any movement of the arms 104 with respect to the frame 102 and/or any movement of the arms 104 outward from each other.

There are other circumstances in which the system 100 could inadvertently drop the deformable object 114. For example, if the deformable object 114 has very have low rigidity (e.g., in the case of pieces of raw, boneless meat), the reaction force of the deformable object 114 on the lateral contact surfaces 110 may not be sufficient to rotate the fingers 106 outward against the weight of the deformable object 114. Similarly, if the deformable object 114 is very thin, the reaction force of the deformable object 114 on the lateral contact surfaces 110 may not be sufficient to rotate the fingers 106 outward against the weight of the deformable object 114. In either case, the force on the lateral contact surface 110 may not be sufficient to hold the first surfaces 108 in as close to a horizontal position as possible, which could cause the system 100 to inadvertently drop the deformable object 114.

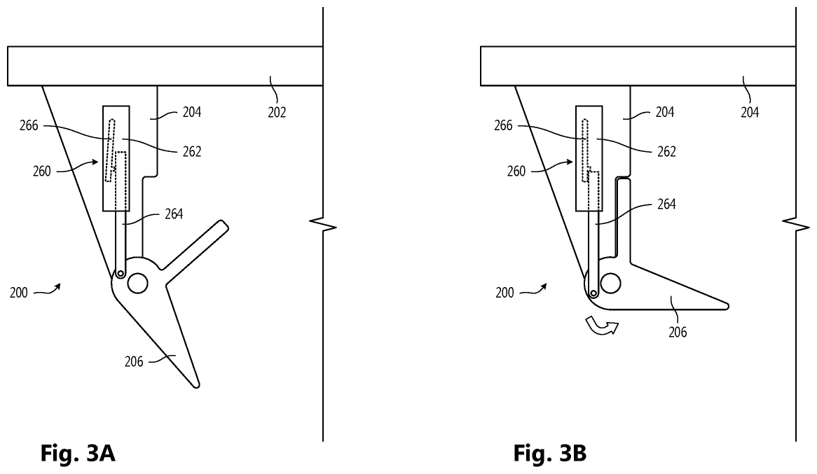

FIGS. 3A and 3B depict partial side views of a system 200 that overcomes the inadvertent dropping problem shown in FIGS. 2A to 2C. The system 200 includes a frame 202, an arm 204 movably coupled to the frame 202, and a finger 206 rotatably coupled to the distal end of the arm 204. In FIG. 3A, the finger 206 is rotated downward to an open position. In FIG. 3B, the finger 206 is rotated upward to a holding position.

The system 200 further includes a locking mechanism 260. In the depicted embodiment, the locking mechanism 260 is coupled to both the arm 204 and the finger 206. In the depicted embodiment, the locking mechanism 260 includes a housing 262 that is fixedly coupled to the arm 204, a rod 264 slidably coupled to the housing 262 and rotatably coupled to the finger 206, and a locking device 266 within the housing 262.

The locking mechanism 260 is configured to selectively be in an unlocked configuration and in a locked configuration. In the depicted instances, the locking mechanism 260 is in the unlocked configuration in FIG. 3A and the locking mechanism 260 is in the locked configuration in FIG. 3B. When the locking mechanism 260 is in the unlocked configuration, the locking mechanism 260 is configured to allow the finger 206 to rotate between the open position in FIG. 3A and the holding position in FIG. 3B. The locking mechanism 260 is configured to transition from the unlocked configuration to the locked configuration in response to the finger 206 rotating to the holding position. In the depicted embodiment, the upward rotation of the finger 206 from FIG. 3A causes the rod 264 to slide downward until the locking device 266 engages the top of the rod 264 in FIG. 3B. In the locked configuration shown in FIG. 3B, the locking mechanism 260 is configured to hold the finger 206 in the holding position.

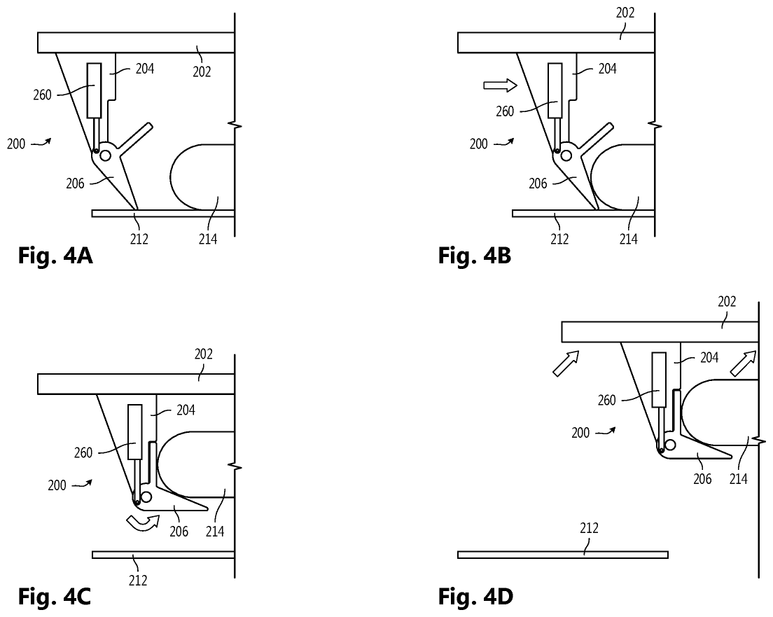

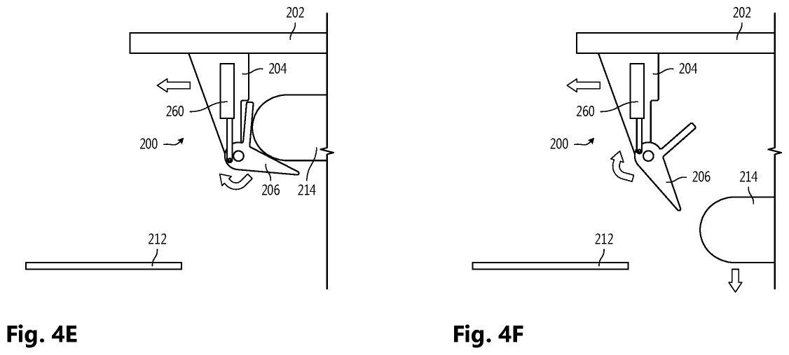

With the locking mechanism 260 holding the finger 206 in the locked configuration, the finger 206 is capable of holding a deformable object without the risk of inadvertent rotation of the finger 206. In this way, the locking mechanism 260 reduces the risk of the system 200 inadvertently dropping the deformable object. FIGS. 4A to 4F depict six instances of a method of using the system 200 to move a deformable object.

FIG. 4A depicts a first instance of the method of using the system 200. In particular, FIG. 4A depicts the system 200, a surface 212, and a deformable object 214 on the surface. The surface 212 and the deformable object 214 can be any type of surface and deformable object, including those embodiments of surfaces and deformable objects described herein. In FIG. 4A, the finger 206 is in the open position. An end of the finger 206 is in contact with the surface 212. The finger 206 is also spaced apart from the deformable object 214.

From the first instance shown in FIG. 4A to the second instance shown in FIG. 4B, the arm 204 has been moved with respect to the frame 202 toward the deformable object 214 until the finger 206 has come into contact with the deformable object 214. The finger 206 remains in the open position. The locking mechanism 260 remains in the unlocked configuration and allows the finger 206 to rotate between the open configuration and the holding configuration. It will be apparent that the embodiment of the system 200 shows only a portion of the system 200 and the deformable object 214 and that the system could include another arm and finger on the other side of the deformable object 214 that operates similar to the arm 204 and the finger 206.

From the second instance shown in FIG. 4B to the third instance shown in FIG. 4C, the arm 204 has been further moved with respect to the frame 202 toward the deformable object 214. The movement of the arm 204 has caused the deformable object 214 to exert a force on the lateral surface of the finger 206 to cause the finger 206 to rotate upward. The upward rotation of the finger 206 caused the finger 206 to lift the deformable object 214 off of the surface 212. In FIG. 4C, the finger 206 has rotated until the finger 206 has reached the holding position. The locking mechanism 260 is configured to transition from the unlocked configuration to the locked configuration in response to the finger 206 rotating to the holding position. Thus, in FIG. 4C, the locking mechanism is in the locked configuration because the finger 206 has already rotated to the holding position. When the locking mechanism 260 is in the locked configuration, the locking mechanism 260 holds the finger 206 in the holding position. This holding of the finger 206 in the holding position by the locking mechanism 260 reduces the possibility of the finger 206 inadvertently dropping the deformable object 214.

From the third instance shown in FIG. 4C to the fourth instance shown in FIG. 4D, the system 200 has been moved away from the surface 212. During the movement of the system 200 to the position shown in FIG. 4D, the finger 206 in the holding position at least in part due to the holding of the finger 206 in the holding position by the locking mechanism 260. During the movement of the system 200 from the third instance shown in FIG. 4C to the fourth instance shown in FIG. 4D, the arm 204 does not move with respect to the frame 202. As will be apparent, the system 200 can include another arm, finger, and locking mechanism on other side of the deformable object 214, which will aid in holding the side of the deformable object 214 that is not visible in FIG. 4D.

In some embodiments, the location of the system 200 at the fourth instance shown in FIG. 4D is the location where the system 200 is to place the deformable object 214. Between the fourth instance shown in FIG. 4D and the fifth instance shown in FIG. 4E, the arm 204 has started moving with respect to the frame 202 in a direction that is away from the deformable object 214. The locking mechanism 260 is configured to transition from the locked configuration to the unlocked configuration in response to movement of the arm 204 with respect to the frame 202 in the direction away from the deformable object 214. Thus, as the arm 204 begins to move with respect to the frame 202 away from the deformable object 214, the locking mechanism 260 transitions to the unlocked configuration and then allows the finger 206 to rotate downward. Thus, in the fifth instance shown in FIG. 4E, the movement of the arm 204 away from the deformable object 214 causes both the finger 206 to move away from the deformable object and the finger to rotate downward. Both of these actions will start the process of allowing the deformable object 214 to be released from the system 200.

Between the fifth instance shown in FIG. 4E and the sixth instance shown in FIG. 4F, the arm 204 has continued moving with respect to the frame 202 in the direction away from the deformable object 214. In addition, the finger 206 has been allowed to rotate downward toward the open position due to the force of gravity and/or the weight of the deformable object 214; the locking mechanism 260 has not prevented rotation of the finger to the open position. The movement of the arm 204 away from the deformable object 214 and/or the downward rotation of the finger 206 has allowed the deformable object 214 to fall from the system 200. In this way, the movement of the of the arm 204 away from the deformable object 214 alone allows the deformable object 214 to fall away from the system 200. In some embodiments, the locking mechanism 260 is a passive locking mechanism in that it is arranged to automatically transition from the locked configuration to the unlocked configuration in response to movement of the arm 204 with respect to the frame 202 away from the deformable object 214 without the use of a controller and/or an independent or dedicated actuator to control the locking mechanism 260 and/or sensors to detect the movement of the arm 204 with respect to the frame 202. In other embodiments, the locking mechanism 260 is an active locking mechanism that includes a controller which controls the transition of the locking mechanism 260 from the locked configuration to the unlocked configuration in response to movement of the arm 204 with respect to the frame 202 away from the deformable object 214. In some cases, the active locking mechanism may also include one or more sensors to detect the movement of the arm 204 with respect to the frame 202 and to indicate to the controller when the arm 204 has moved with respect to the frame 202.

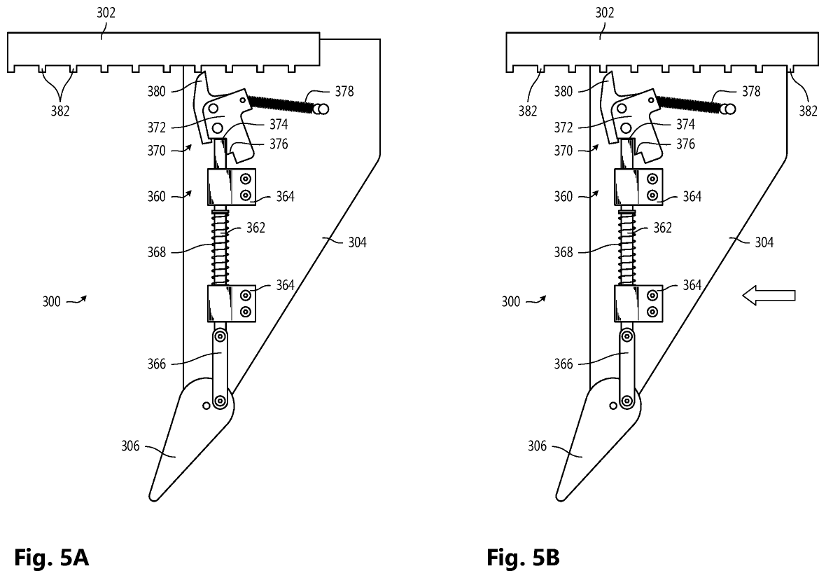

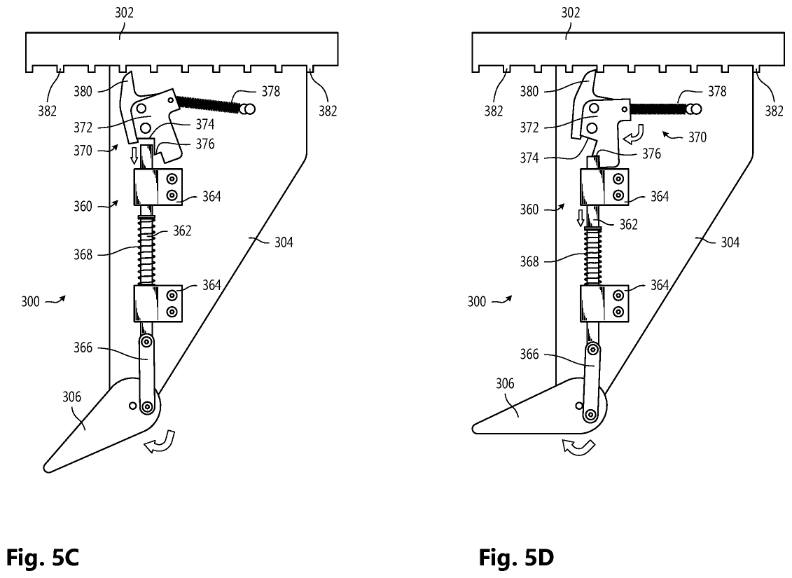

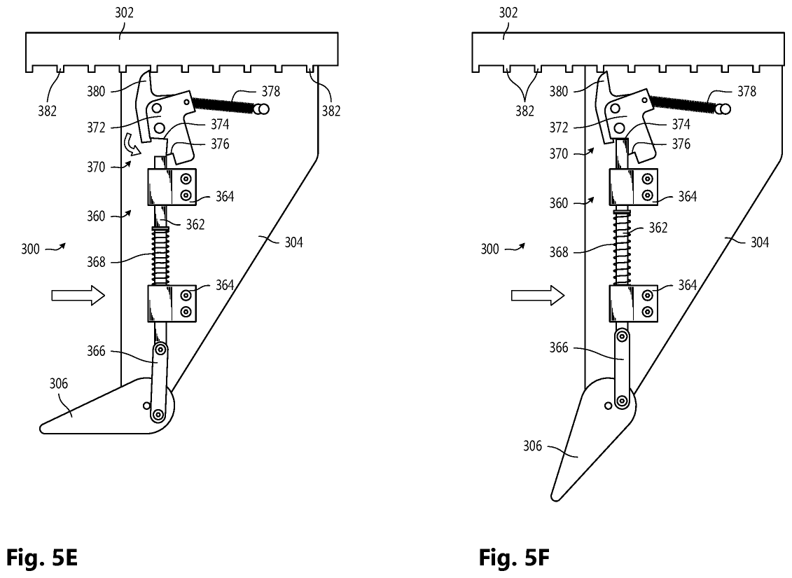

FIGS. 5A to 5F depict an embodiment of a system 300 that includes passive locking mechanism 360 and instances of the operation of the passive locking mechanism 360. The system 300 includes a portion of a frame 302, an arm 304 capable of moving with respect to the frame 302, and a finger 306 rotatably coupled to the distal end of the arm 304. The system 300 further includes a locking mechanism 360 that can selectively be in an unlocked configuration and in a locked configuration. As discussed in greater detail below, the locking mechanism 360 is configured to allow the finger 306 to rotate between the open position and the holding position when the locking mechanism 360 is in the unlocked configuration, transition from the unlocked configuration to the locked configuration in response to the finger 306 rotating to the holding position, hold the finger 306 in the holding position when the locking mechanism 360 is in the locked configuration, and transition from the locked configuration to the unlocked configuration in response to movement of the arm 304 with respect to the frame 302 to the right (when viewing the system 300 in FIGS. 5A to 5F.

As noted above, any of the locking mechanisms described herein can be passive locking mechanisms. In the particular embodiment shown in FIGS. 5A to 5F, the locking mechanism 360 is a passive locking mechanism. The particular embodiment of the locking mechanism is described below. It will be apparent that, in other embodiments, different embodiments of passive locking mechanisms can provide similar functionality. It will also be apparent that, in other embodiments, active locking mechanisms could also provide similar functionality.

The locking mechanism 360 includes a rod 362 configured to slide with respect to the arm 304. In the depicted embodiment, the rod 362 is configured to slide through bearings or bushings that are fixedly coupled to the arm 304. The distal end of the rod 362 is coupled to the finger 306. In the particular example shown, the distal end of the rod 362 is coupled to the finger 304 via an extension bracket 366. The rod 362 is rotatable coupled to one end of the extension bracket 366 and the finger 306 is rotatably coupled to the other end of the extension bracket 366. The rod 362 is biased upward by a biasing mechanism 368. In the depicted embodiment, the biasing mechanism 368 is a compression spring that engages one of the bearings or bushings 364 to bias the rod 362 upward with respect to the arm 304. In the upper end of the biasing mechanism 368 contacts a collar that is fixedly coupled to the rod. In some embodiments, the collar is an integrated collar that is integrated with the rod 362 or a removable collar that can be removed from the rod 362 (e.g., a crosspin).

The locking mechanism 360 further includes a head 370 that is rotatably coupled to the arm 304. In the depicted embodiment, the head 370 includes a body 372 that is rotatably coupled to the arm 304. The body 372 includes a first surface 374 and a second surface 376, each of which is configured to engage the proximal end of the rod 362. As discussed in greater detail below, the locking mechanism 360 is in the unlocked configuration when the first surface 374 engages the proximal end of the rod 362 and the locking mechanism is in the locked configuration when the second surface 376 engages the proximal end of the rod 362. In other embodiments, the collar of the rod 362 may contact one of the bearings or bushings 364 before the proximal end of the rod 362 reaches the first surface 362 and the locking mechanism 360 is in the unlocked configuration when the collar of the rod 362 is in contact with one of the bearings or bushings 364. In the depicted embodiment, the head 370 is rotationally biased by a biasing mechanism 378 that biases the head 370 to rotate in the clockwise direction (when viewing FIGS. 5A to 5F). In the depicted embodiment, the biasing mechanism 378 is a tension spring.

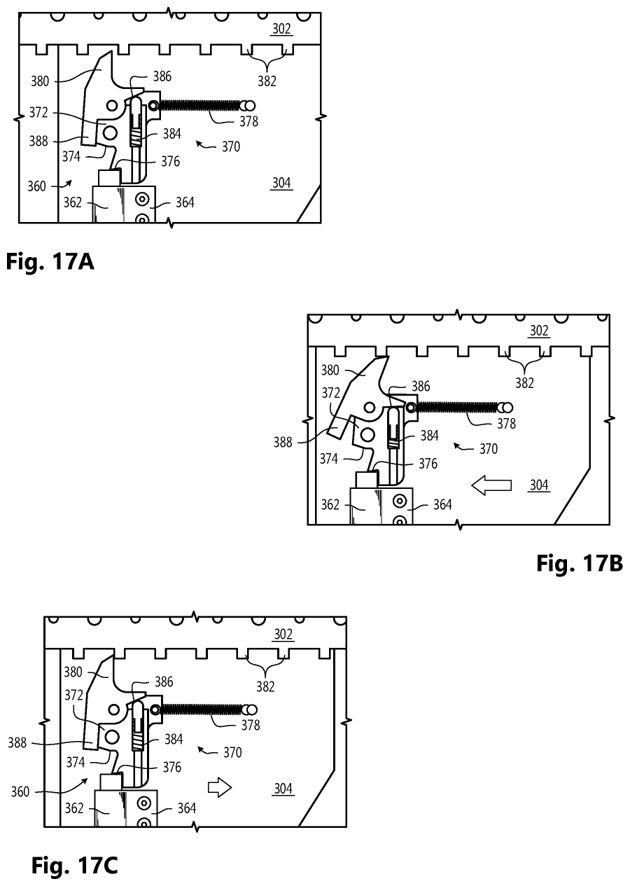

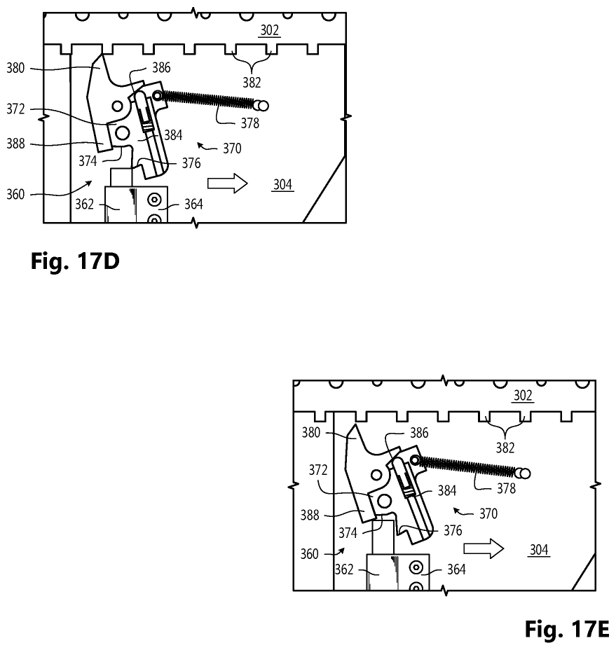

The head 370 further includes a pawl 380 that extends above the body 372. In some embodiments, the pawl 380 is rotationally coupled to the body 372. In some embodiments, the pawl 380 is rotationally biased with respect to the body 372 in a counterclockwise direction. Further details about the rotational movement of the pawl 380 with respect to the body 372 are provided below in FIGS. 17A to 17E. The frame 302 also includes teeth 382 that extend downward in the direction of the pawl 380. As discussed in detail below, the pawl 380 is configured to engage with the teeth 382 to effect the passive transition of the locking mechanism 360 from the locked configuration to the unlocked configuration in response to movement of the arm 304 with respect to the frame 302 in the direction to the right when viewing FIGS. 5A to 5F. This interaction is shown in the method depicted by the instances from FIG. 5A to FIG. 5F.

FIG. 5A depicts a first instance of the method in which the locking mechanism 360 is in the unlocked configuration. In particular, the proximal end of the rod 362 is engaged by the first surface 374 of the body 372 of the head 370. The finger 306 is in the open position. The locking mechanism 360 allows the finger 306 to rotate from the open position toward the holding position. In particular, if the finger 306 were rotated upward, clockwise rotation of the finger 306 would cause the extension bracket 366 and the rod 362 to be pulled downward. With sufficient force exerted on the rod 362 to overcome the force of the biasing mechanism 368, the locking mechanism 360 would not prevent the downward sliding movement of the rod 362 with respect to the arm 304.

From the first instance shown in FIG. 5A to the second instance shown in FIG. 5B, the arm 304 has been moved to the left with respect to the frame 302. The pawl 380 is positioned and/or shaped in a way that allows the pawl 380 to pass by the teeth 382 as the arm 304 moves to the left with respect to the frame 302. In the embodiments where the pawl 380 is capable of rotating with respect to the body 372, the pawl 380 may rotate with respect to the body 372 if the pawl 380 contacts one or more of the teeth 382 as the arm 304 moves to the left with respect to the frame 302.

From the second instance shown in FIG. 5B to the third instance shown in FIG. 5C, the finger 306 has begun rotating from the open position toward the holding position. The rotation of the finger 306 can be caused by any force on the finger 306, such as contact with a surface, contact with a deformable object, and the like. While the locking mechanism 360 is in the unlocked configuration, the locking mechanism 360 allows the finger 306 to rotate between the open position and the holding position. In the depicted embodiment, the rotation of the finger 306 causes the rod 362 to move downward. As can be seen in FIG. 5C, no element of the locking mechanism prevents or deters the rod 362 from moving downward as the finger 306 rotates from the open position toward the holding position. In FIG. 5C, the finger 306 has not yet reached the holding position and the proximal end of the rod 362 has not yet reached the second surface 376.

From the third instance shown in FIG. 5C to the fourth instance shown in FIG. 5D, the finger 306 has continued rotating until the finger 306 reached the holding position in FIG. 5D. In response to the finger 306 reaching the holding position, the locking mechanism 360 transitioned from the unlocked configuration to the locked configuration. In the depicted embodiment, the rotation of the finger 306 to the holding position caused the proximal end of the rod 362 to be lowered beneath the second surface 376. Once the proximal end of the rod 362 is below the second surface 376, the biasing mechanism 378 causes the head 370 to rotate in a clockwise direction (when viewing FIG. 5D) so that the second surface 376 is located above the proximal end of the rod 362. In this position, the second surface 376 prevents the rod 362 from moving upward from the position shown in FIG. 5D which also prevents the finger 306 from rotating from the holding position toward the open position. Thus, when the locking mechanism 360 is in the locking configuration, the locking mechanism 360 holds the finger 306 in the holding position.

In the depicted embodiment, the arm 304 can move to the left with respect to the frame 302 when the locking mechanism 360 is in the locked configuration and the locking mechanism 360 will remain in the locked configuration. Similarly, the entire system 300 can be moved while the locking mechanism 360 remains in the locked configuration so long as the arm 304 does not move to the right with respect to the frame 302. Movement of the arm 340 to the left pushes the pawl 380 under the teeth 382 and then the pawl 182 returns to its original position by a spring and plunger combination located inside of the body 372. Returning the pawl 380 to its original position allows the pawl 380 to engage the teeth 382 when the arm 304 is moved to the right with respect to the frame 302. This temporary decoupling of the pawl 380 from the head 370 results in no impact on locked configuration of the locking mechanism 360 when the pawl 380 slides by the teeth 382 as the arm 304 moves left with respect to the frame 302. However, movement of the arm 304 to the right with respect to the frame 302 will cause the locking mechanism 360 to transition from the locked configuration to the unlocked configuration. In the depicted embodiment, the clockwise rotation of the head 370 into the locking configuration has raised the pawl 380 so that the tip of the pawl 380 is located between two of the teeth 382. As discussed below, movement of the arm 304 to the right with respect to the frame will cause the pawl 380 to interact with one of the teeth 382 to cause the locking mechanism 360 to transition from the locked configuration to the unlocked configuration.

From the fourth instance shown in FIG. 5D to the fifth instance shown in FIG. 5E, the arm 304 has moved to the right with respect to the frame 302. In response to the movement of the arm 304 to the right with respect to the frame 302, the pawl 380 has engaged one of the teeth 382. The further movement of the arm 304 while the pawl 380 is engaged with one of the teeth 382 has cause the head 370 to rotate counterclockwise against the force of the biasing mechanism 378. At the fifth instance shown in FIG. 5E, a portion of the second surface 376 is still located above the proximal end of the rod 362, which prevents the rod 362 from sliding upward. However, all will be appreciated, further rotation of the head 370 will cause the second surface 376 to be completely removed from the proximal end of the rod 362 so that the rod 362 can slide upward to the first surface 374.

From the fifth instance shown in FIG. 5E to the sixth instance shown in FIG. 5F, the arm 304 has continued to move further to the right with respect to the frame 302. The further movement of the arm 304 with respect to the frame 302, in combination with the interaction of the pawl 380 with one of the teeth 382, has caused the head 370 to rotate to the point that the second surface 376 has been completely removed from the proximal end of the rod 362 and the rod 362 has slid upward until it contacted the first surface 374 so that the locking mechanism 360 has transitioned into the unlocked configuration. In the depicted embodiment, the biasing mechanism 362 has raised the rod 362 once the second surface 376 was completed removed from the proximal end of the rod 362. At this point, the locking mechanism 360 is back to the same unlocked configuration as it was in at the first instance in FIG. 5A and the entire process can be repeated again.

It will be noted that the movement of the arm 304 to the right with respect to the frame does not necessarily cause an immediate transition of the locking mechanism 360 to the unlocked configuration. In one example, the spacing of the teeth 382 may allow for the arm 304 to move some small distance before the pawl 380 engages one of the teeth 382. In some embodiments, the spacing between the teeth 382 (i.e., the spacing between any two consecutive ones of the teeth 382) is less than or equal 0.75 inches (1.91 cm). In another example, the length of the engagement surface (i.e., the surface the end of distal end of the rod 362 coupled to the finger 306 that engages the finger 306) is the “sear” engagement length. In some embodiment, the sear engagement length is equal to the rod radius. In another example, the distance the arm 304 is able to move with respect to the frame 302 before the locking mechanism transitions from the locked configuration to the locked configuration is a function of both the sear length and the tooth spacing. With a smaller sear engagement length, the tooth spacing can also be reduced.

In yet another example, rotation of the finger 306 is also a factor in the distance the arm 304 is able to move with respect to the frame 302 before the locking mechanism transitions from the locked configuration to the locked configuration. The finger 306 rotates in a range of angles between the open position and the holding position. In some embodiments, when the finger 306 is in the open position, the contact surface of the finger 306 is at a non-vertical angle, such as at least 5° away from vertical. In some embodiments, when the finger 306 is in the holding position, the contact surface of the finger 306 is at or below horizontal. When these embodiments are combined, the finger 306 is capable of rotating between the open position and the holding position in a range of angles that is less than or equal to 85°, such as between 5° off vertical in the open position and horizontal in the holding position. More practically, when the finger 306 is in the open position, the contact surface of the finger 306 can be farther away from vertical, such as at an angle of 20° away from vertical, and, when the finger 306 is in the holding position, the contact surface of the finger 306 can be away from horizonal, such as at an angle of 30° away from vertical. In other embodiments, the range of angles of the finger 306 between the open position and the holding position is smaller than 85°, such as a 40° range. The smaller the range of rotation of the finger 306 between the open position and the holding position, the less distance the rod 362 needs to travel to transition the locking mechanism 360 between the unlocked configuration and the locked configuration.

The process shown in FIGS. 5A to 5F demonstrates the operation of one embodiment of a passive locking mechanism. In particular, the transition of the locking mechanism 360 from the unlocked configuration to the locked configuration occurs in response to rotation of the finger 306 from the open position to holding position. No active controller was required to cause the locking mechanism 360 to transition from the unlocked configuration to the locked configuration. Similarly, the transition of the locking mechanism 360 from the locked configuration to the unlocked configuration occurs in response to outward movement (i.e., movement to the right when viewing FIGS. 5A to 5F) of the arm 304 with respect to the frame 302. No active controller was required to cause the locking mechanism 360 to transition from the unlocked configuration to the locked configuration. While the locking mechanism 360 is in the unlocked configuration, the locking mechanism 360 allows the finger 306 to rotate between the open position and the holding position. And, while the locking mechanism 360 is in the locked configuration, the locking mechanism 360 holds the finger 306 in the holding position.

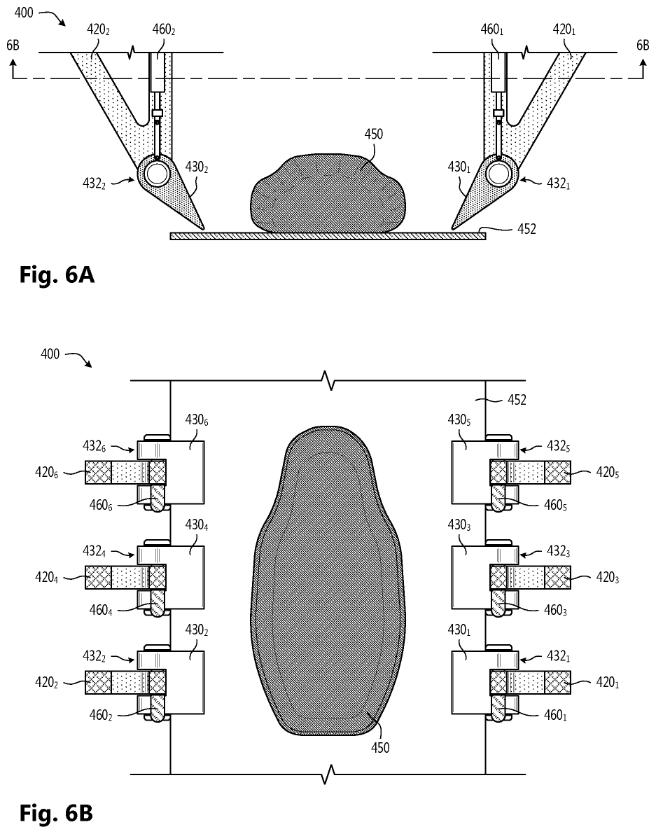

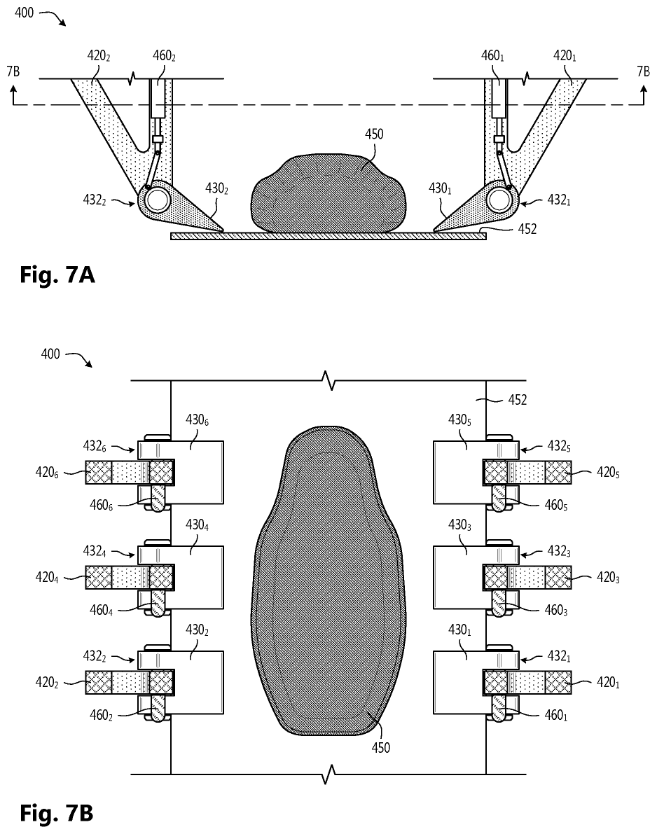

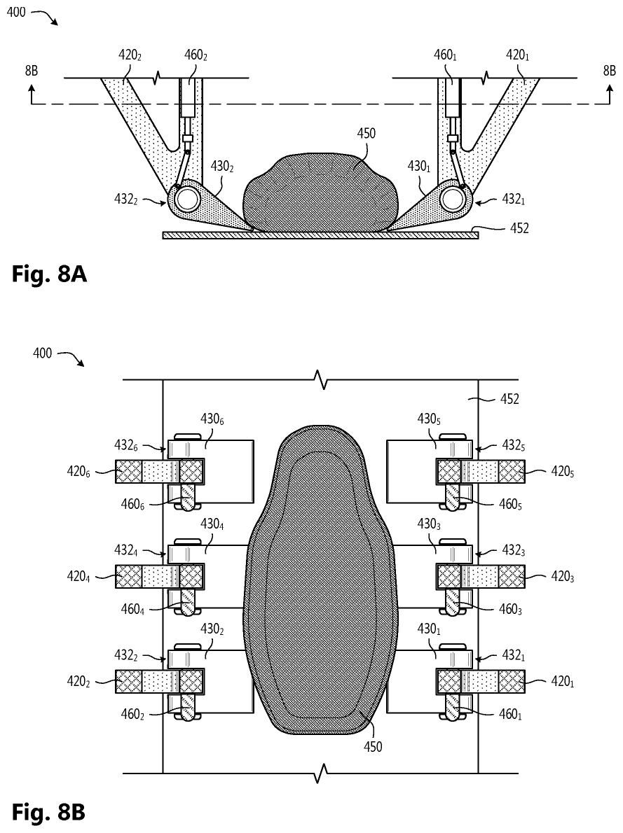

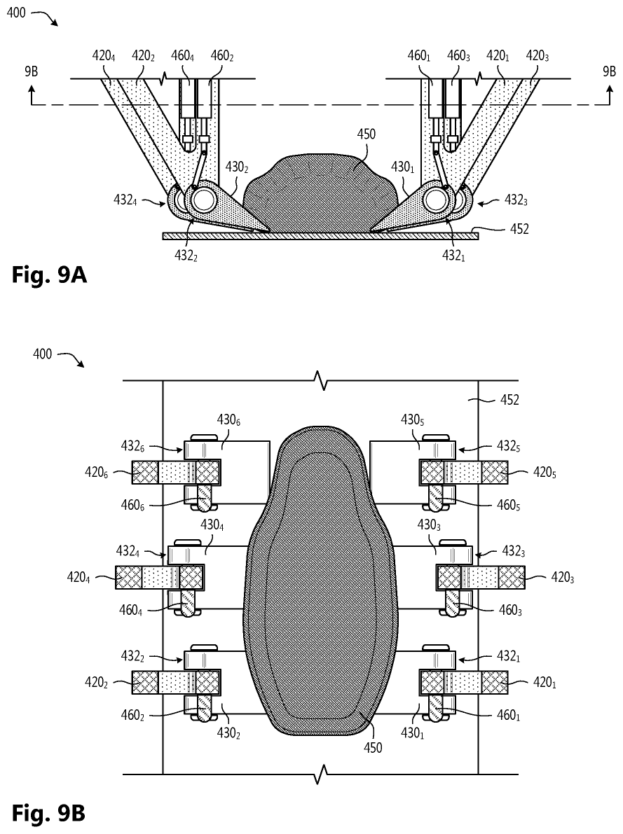

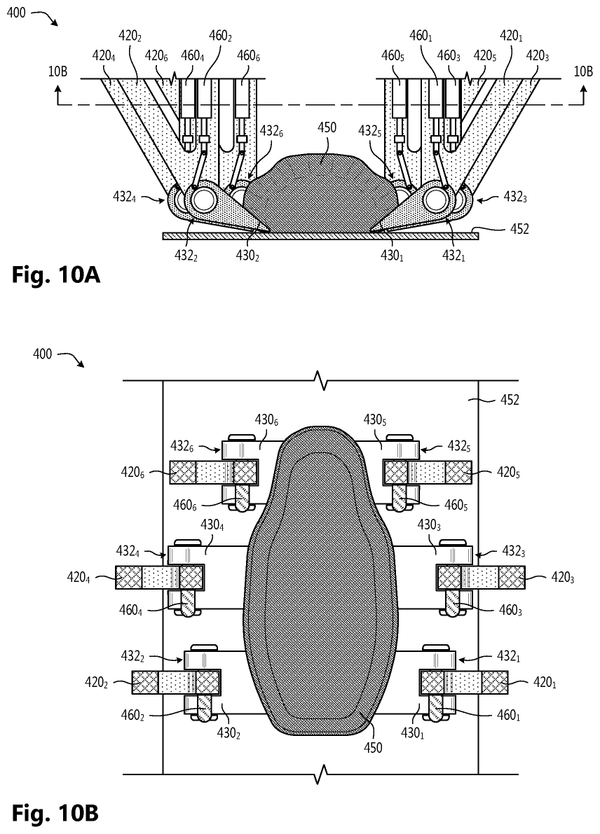

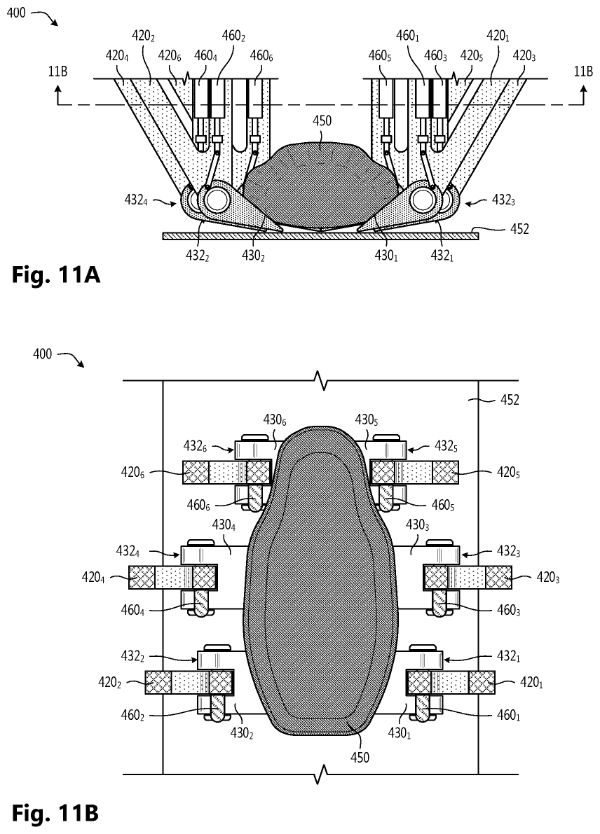

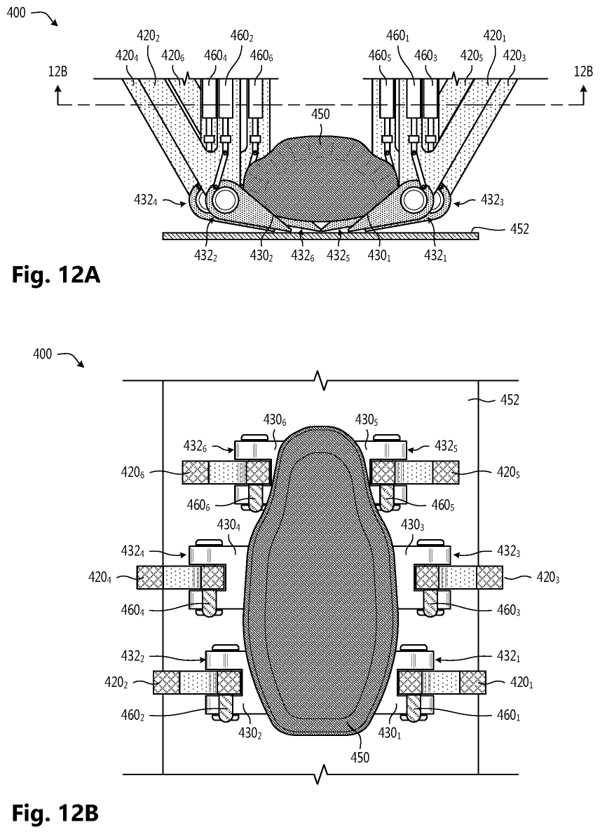

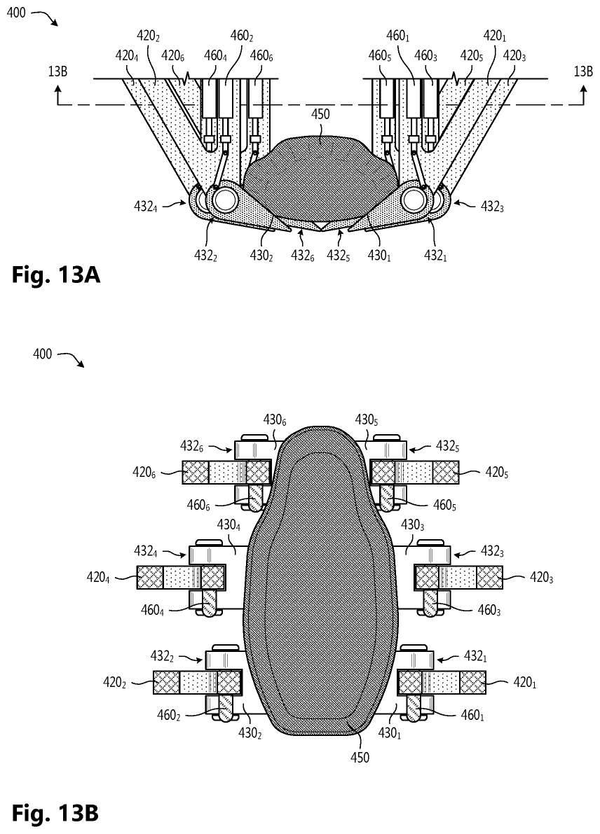

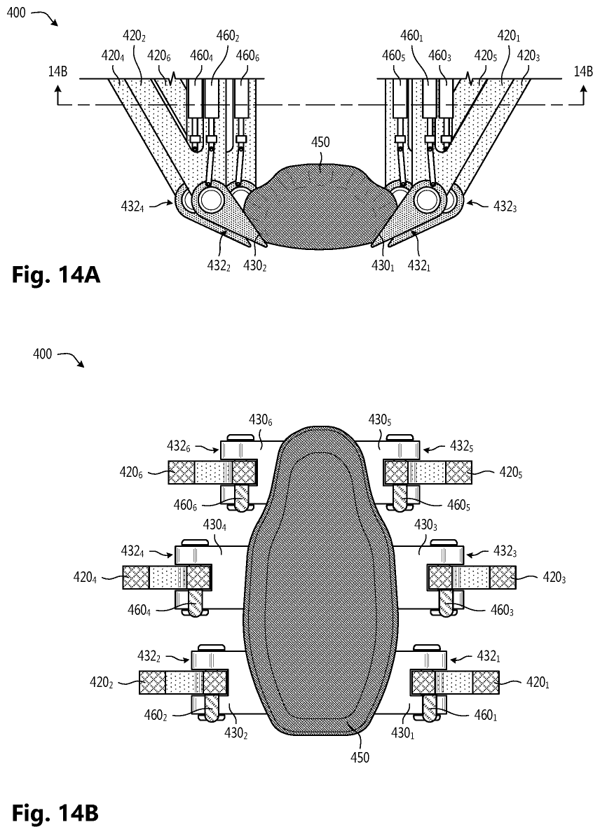

Depicted in FIGS. 6A to 14B is an embodiment of a system 400 can be used to lift a deformable object from a surface and a method of the system 400 being used to lift a deformable object 450 from a surface 452. More specifically, FIGS. 6A and 6B depict a partial front view and a top cross-sectional view, respectively, of a first instance of the method; FIGS. 7A and 7B depict a partial front view and a top cross-sectional view, respectively, of a second instance of the method; FIGS. 8A and 8B depict a partial front view and a top cross-sectional view, respectively, of a third instance of the method; FIGS. 9A and 9B depict a partial front view and a top cross-sectional view, respectively, of a fourth instance of the method; FIGS. 10A and 10B depict a partial front view and a top cross-sectional view, respectively, of a fifth instance of the method; FIGS. 11A and 11B depict a partial front view and a top cross-sectional view, respectively, of a sixth instance of the method; FIGS. 12A and 12B depict a partial front view and a top cross-sectional view, respectively, of a seventh instance of the method; FIGS. 13A and 13B depict a partial front view and a top cross-sectional view, respectively, of an eighth instance of the method; and FIGS. 14A and 14B depict a partial front view and a top cross-sectional view, respectively, of a ninth instance of the method. Embodiments of the system 400 are depicted in co-pending patent application PCT/US2021/012130, filed Jan. 5, 2021, the contents of which are hereby incorporated by reference in their entirety.

The system 400 includes a support structure (not shown) that includes a frame. The frame is configured to hold a pair of opposing arms, as discussed in greater detail below. The support structure can be coupled in parallel to a fluid power system (e.g., a pneumatic system or a hydraulic system). The system 400 is configured to move the arms coupled by changing the pressure in the fluid power system. In the depicted embodiment, the support structure is further configured to be coupled to a movement device (e.g., a conveyor, a robotic arm, or any other device capable of movement) in order to couple the system 400 to the movement device.

The system 400 also includes arms 420₁, 420₂, 420₃, 420₄, 420₅, 420₆ (collectively, arms 420). The arms 420₁ and 420₂ are movably coupled to the support structure and form a pair of opposing arms. The arms 420₁ and 420₂ are capable of moving translationally toward and away from each other. In some embodiments, the arms 420₁ and 420₂ are biased away from each other by a biasing mechanism (e.g., a compression spring) to the positions shown in FIGS. 6A and 6B. One or both of the arms 420₁ and 420₂ can be moved toward the other, such as by increasing the pressure in the fluid power system.

Similarly, the arms 420₃ and 420₄ are movably coupled to the support structure and form a pair of opposing arms. The arms 420₅ and 420₆ are also movably coupled to the support structure and form a pair of opposing arms. The arms 420₃ and 420₄ are capable of moving translationally toward and away from each other and the arms 420₅ and 420₆ are capable of moving translationally toward and away from each other. In some embodiments, the arms 420₃ and 420₄ are biased away from each other by a biasing mechanism and the arms 420₅ and 420₆ are biased away from each other by a biasing mechanism to the positions shown in FIGS. 6A and 6B. One or both of the arms 420₃ and 420₄ can be moved toward the other, such as by increasing the pressure in the fluid power system. One or both of the arms 420₅ and 420₆ can be moved toward the other, such as by increasing the pressure in the fluid power system.

The system 400 further includes inclined surfaces 430₁, 430₂, 430₃, 430₄, 430₅, 430₆ (collectively, inclined surfaces 430). The inclined surfaces 430 are configured to contact sides of a deformable object as a deformable object is being lifted by the system 400. The inclined surfaces 430₁, 430₂, 430₃, 430₄, 430₅, 430₆ are located on the arms 420₁, 420₂, 420₃, 420₄, 420₅, 420₆, respectively. In the depicted embodiment, the system 400 further includes fingers 432₁, 432₂, 432₃, 432₄, 432₅, 432₆ (collectively, fingers 432 ) that are rotatably coupled to the distal ends of the arms 420₁, 420₂, 420₃, 420₄, 420₅, 420₆, respectively. In this embodiment, the fingers 432₁, 432₂, 432₃, 432₄, 432₅, 432₆ include the inclined surfaces 430₁, 430₂, 430₃, 430₄, 430₅, 430₆, respectively. In the depicted embodiment, the fingers 432₁, 432₂, 432₃, 432₄, 432₅, 432₆ are removably coupled to the distal ends of the arms 420₁, 420₂, 420₃, 420₄, 420₅, 420₆, by pins. The ability to easily (e.g., manually without the aid of tools) remove the fingers 432 from the distal ends of the arms 420 allows the fingers 432 to be quickly removed from the arms 420, such as for cleaning of the fingers 432. In some embodiments, the biasing mechanisms described herein can include one or more of a compression spring, a piston/cylinder mechanism, a Belleville washer stack, or any other biasing mechanism. At the first instance shown in FIGS. 6A and 6B, the fingers 432 have been rotated downward by gravity. In some embodiments, the fingers 432 are capable of rotating within a range of rotational positions and the positions of the fingers 432 shown in FIGS. 6A and 6B are the lowermost rotational positions within the range of possible positions of the fingers 432. In the depicted embodiment shown in FIGS. 6A and 6B, the fingers 432 can be considered to be in an open position.

The system 400 further includes locking mechanisms 460₁, 460₂, 460₃, 460₄, 460₅, 460₆ (collectively, locking mechanisms 460) that are coupled to the distal ends of the fingers 432₁, 432₂, 432₃, 432₄, 432₅, 432₆, respectively. The locking mechanisms 460 are configured to selectively be in an unlocked configuration and in a locked configuration. In the first instance shown in FIGS. 6A and 6B, when the locking mechanisms 460 are in an unlocked configuration, the locking mechanisms 460 allow the fingers 432 to rotate between the open position and a holding position.

FIGS. 6A and 6B depict a deformable object 450. The deformable object 450 can be a food product, such as a piece of raw meat, a vacuum-sealed piece of raw meat, a piece of fresh produce, or any other type of food product. In the depicted embodiment, the deformable object 450 is located on a surface 452. In some embodiments, the surface 452 can be a conveyor belt, a table top, a shelf, or any other type of surface.

From the first instance shown in FIGS. 6A and 6B to the second instance shown in FIGS. 7A and 7B, the arms 420 have been lowered until the fingers 432 contacted the surface 452 and caused the fingers 432 to rotate. In particular, when viewing FIG. 7A, the fingers 432₁, 432₃, and 432₅ rotated clockwise and the fingers 432₂, 432₄, and 432₆ rotated counterclockwise. In the depicted embodiment shown in FIGS. 7A and 7B, the fingers 432 can be considered to be in the holding position. That rotation of the fingers 432 is possible when the locking mechanisms 460 are in the unlocked configuration. In the depicted embodiment, the locking mechanisms 460 are configured to transition from the unlocked configuration to the locked configuration in response to the fingers 432 rotating to the holding position. In particular, in the depicted embodiment, the locking mechanisms 460 are configured to automatically and passively transition to the locked configuration in response to the fingers 432 rotating to the holding position. The locking mechanisms 460 are further configured to hold the fingers 432 in the holding position when the locking mechanisms 460 are in the locked configuration.

In the second instance shown in FIGS. 7A and 7B, the deformable object 450 is on the surface 452 and the system 400 is oriented such that one of the arms 420 in each of the pairs of opposing arms is on either side of the deformable object 450. In some embodiments, the system 400 is coupled to the end of a robotic arm and the robotic arm is configured to position the system 400 with respect to the object 450 as shown in FIGS. 7A and 7B, including moving the system 400 to cause the rotation of the fingers 432 due to contact with the surface 452.

In some embodiments, the system 400 includes a driving mechanism for each of the pairs of arms. Each driving mechanism is configured to move one or both of the arms in a pair of opposing arms (e.g., the arms 420₁ and 420₂, the arms 420₃ and 420₄, or the arms 420₅ and 420₆) toward the other. In some embodiments, the driving mechanism can include one or more of a belt and wheel assembly, a rack and pinion system, a rope and pully system, or any other mechanism that can move the arms and/or overcome the biasing force of the biasing mechanisms. In some embodiments, the driving mechanisms are configured such that each of the pairs of opposing arms is center-justified. For example, with a driving mechanism configured to drive the arms 420₁ and 420₂, movement of the arm 420₁ toward or away from the arm 420₂ causes a corresponding movement of the arm 420₂ toward or away from the arm 420₁. In other embodiments, the driving mechanisms can be configured such that each of the pairs of opposing arms is side-justified, where one of the arms in each pair of opposing arms does not move with respect to the support structure. In the second instance depicted in FIGS. 7A and 7B, the arms 420 in each of the pairs of opposing arms are biased away from each other by the biasing mechanisms 422 as far as the support structure 410 allows.

The driving mechanism can increase the force on the arms 420 from the second instance shown in FIGS. 7A and 7B until the pressure reaches a predetermined level. In the depicted embodiment, the force exerted on the arms 420 by the driving mechanism is increased after the second instance shown in FIGS. 7A and 7B until the seventh instance shown in FIGS. 12A and 12B. Each of the second through seventh instances in FIGS. 7A to 12B shows a level of force exerted on the arms 420 by the driving mechanism that is greater than the previous instance. In the seventh instance shown in FIGS. 12A and 12B, the force exerted on the arms 420 by the driving mechanism has reached the predetermined level.

From the second instance shown in FIGS. 7A and 7B to the third instance shown in FIGS. 8A and 8B, the force exerted on the arms 420 by the driving mechanism has increased to cause the pairs of opposing arms to move toward each other. In particular, the arm 420₁ and the arm 420₂ have moved toward each other, the arm 420₃ and the arm 420₄ have moved toward each other, and the arm 420₅ and the arm 420₆ have moved toward each other. In the depicted embodiments, the force exerted on the arms 420 by the driving mechanism is substantially the same between each of the pairs of arms before the third instance such that the arms 420₁, 420₃, and 420₅ tend to move substantially the same distance between the second and third instances and the arms 420₂, 420₄, and 420₆ tend to move substantially the same distance between the second and third instances. At the third instance shown in FIGS. 8A and 8B, the inclined surfaces 430₃ and 430₄ of the arms 420₃ and 420₄ have come into contact with the right and left sides, respectively, of the deformable object 450. The deformable object 450 is not perfectly straight along the right and left sides, leaving the inclined surfaces 430₁, 430₂, 430₅, and 430₆ of the arms 420₁, 420₂, 420₅, and 420₆ not in contact with the deformable object 450.

From the third instance shown in FIGS. 8A and 8B to the fourth instance shown in FIGS. 9A and 9B, the force exerted on the arms 420 by the driving mechanism has increased. The resistance to the movement of the arms 420₃ and 420₄ due to the contact between the arms 420₃ and 420₄ and the deformable object 450 is much higher than the resistance to the movement of the arms 420₁ and 420₂ and the arms 420₅ and 420₆ from the driving fluid. In the embodiment where the pair of arms 420₁ and 420₂, the pair of arms 420₃ and 420₄, and the pair of arms 420₅ and 420₆ are coupled to the driving mechanism in parallel, the increase in the force exerted on the arms 420 by the driving mechanism from the third instance to the fourth instance causes the arms 420₁ and 420₂ and the arms 420₅ and 420₆ to continue moving toward each other. Because the pair of opposing arms 420₁ and 420₂ and the pair of opposing arms 420₅ and 420₆ are coupled to the driving mechanism in parallel, the arms 420₁ and 420₅ tend to move substantially the same distance between the second and third instances and the arms 420₂ and 420₆ tend to move substantially the same distance between the third and fourth instances. At the fourth instance shown in FIGS. 9A and 9B, the inclined surfaces 430₁ and 430₂ of the arms 420₁ and 420₂ have come into contact with the right and left sides, respectively, of the deformable object 450. The deformable object 450 is not perfectly straight along the right and left sides, leaving the inclined surfaces 430₅ and 430₆ of the arms 420₅ and 420₆ not in contact with the deformable object 450.

From the third instance shown in FIGS. 8A and 8B to the fourth instance shown in FIGS. 9A and 9B, the driving mechanism has increased the force exerted on the arms 420. The resistance to the movement of the arms 420₁ and 420₂ and the arms 420₃ and 420₄ from the deformable object 450 is much higher than the resistance to the movement of the arms 420₅ and 420₆ from the air. Because the pair of arms 420₁ and 420₂, the pair of arms 420₃ and 420₄, and the pair of arms 420₅ and 420₆ are coupled to the driving mechanism in parallel, the increase in force exerted by the driving mechanism from the third instance to the fourth instance causes the arms 420₅ and 420₆ to continue moving toward each other. At the fourth instance shown in FIGS. 9A and 9B, the inclined surfaces 430₁ and 430₂ of the arms 420₁ and 420₂ have come into contact with the right and left sides, respectively, of the deformable object 450. The deformable object 450 is not perfectly straight along the right and left sides, leaving the inclined surfaces 430₅ and 430₆ of the arms 420₅ and 420₆ not in contact with the deformable object 450.

From the fourth instance shown in FIGS. 9A and 9B to the fifth instance shown in FIGS. 10A and 10B and then to the sixth instance shown in FIGS. 11A and 11B, the driving mechanism has increased the force exerted on the arms 420. Because all of the inclined surfaces 430 were in contact with the deformable object 450 at the fourth instance, the increase in force exerted by the driving mechanism from the fourth instance to the fifth instance caused the arms 420 to exert a compressive force on the deformable object 450. The compressive force exerted by the arms 420 on the deformable object 450 causes the deformable object 450 to slide up the inclined surfaces 430 and begin to lift the deformable object 450 off of the surface 452.

From the sixth instance shown in FIGS. 11A and 11B to the seventh instance shown in FIGS. 12A and 12B, the driving mechanism has increased the force exerted on the arms 420. The increase in pressure in the fluid power system 442 from the sixth instance to the seventh instance caused the arms 420 to further exert a compressive force on the deformable object 450. In particular, in the seventh instance, the force exerted by the driving mechanism has been increased to the predetermined level of force. The compressive force exerted by the arms 420 on the deformable object 450 causes the deformable object 450 to further slide up the inclined surfaces 430 and lift the deformable object 450 farther from the surface 452. In some embodiments, the predetermined level of force is selected based on one or more of a desired amount of compressive force to be applied by the arms 420 on the deformable object 450, a desired height that the deformable object 450 is lifted from the surface 452, or any other desired result of the movement of the arms 420.

The embodiment of the system 400 includes three pairs of opposing arms 420. It will be apparent that the system 400 could have any plurality of pairs of opposing arms, such as two pair of opposing arms, four pairs of opposing arms, or any other number of pairs of opposing arms. In some embodiments, a greater number of pairs of opposing arms may allow the arms to better conform to the shape of a deformable object. However, a greater number of pairs of opposing arms also adds complexity to the system. In some embodiments, a number of pairs of opposing arms—such as three pairs of opposing arms or four pairs of opposing arms—may be selected based on a desired amount of conformity with deformable objects, a desired amount of complexity of the system, and expected size and/or shape of the deformable objects that will be lifted by the system, any other factor, or any combination thereof.

The embodiment of the method depicted in FIGS. 4A to 12B shows some of the benefits of the system 400 where the driving mechanism is coupled in parallel to the pair of opposing arms 420₁ and 420₂, the pair of opposing arms 420₃ and 420₄, and the pair of opposing arms 420₅ and 420₆. One of the benefits is that each of the pairs of opposing arms is able to close a different distance around the deformable object 450 while being driven at substantially the same force in the direction of travel. In the depicted example, the pair of opposing arms 420₃ and 420₄ moved toward each other the least amount until the inclined surfaces 430₃ and 430₄ contacted the deformable object 450, the pair of opposing arms 420₁ and 420₂ moved toward each other a greater amount until the inclined surfaces 430₁ and 430₂ contacted the deformable object 450, and the pair of opposing arms 420₅ and 420₆ moved toward each other the greatest amount until the inclined surfaces 430₅ and 430₆ contacted the deformable object 450. In other embodiments, where the deformable object 450 has a different size and/or shape, each of the pairs of opposing arms can close a different length based on the size and/or shape of the deformable object 450. Where the system 400 is used to pick up many different deformable objects that have different shapes and/or sizes, the closing of the pairs of opposing arms conforms to the shape and/or size of each of the deformable objects.

Another benefit of the system 400 is that the arms 420 can conform to a unique shape and/or size of a deformable object without a feedback system located on the arms 420. In the system 400, there is no need to measure an amount of force exerted by each of the arms 420, to measure the distance traveled by each of the arms 420, to determine whether each of the arms 420 has come into contact with the deformable object 450, and the like. All of the functions of the arms 420 can be passively controlled (i.e., controlled without direct measurement of any of the aspect of the arms) by controlling the force exerted on the arms 420 by the driving mechanism. In the case where the system 400 is used to lift deformable food products (e.g., cuts of raw meat), any portion of the system 400 that can come into contact with the deformable food products must be cleaned and/or replaced on a regular basis. Not having extra equipment on the arms 420, such as feedback sensors, actuators, and the like, greatly reduces the number of pieces of the system 400 that are subject to cleaning and/or replacement due to potential contact with food products.

Another benefit of the system 400 is that the arms 420 are able to reliably and stably lift the deformable object 450. If the arms 420₁, 420₃, and 420₅ were required to move in unison and the arms 420₂, 420₄, and 420₆ were required to move in unison, the result would be an unstable lift of the deformable object 450. For example, after the inclined surfaces 430₃ and 430₄ initially contacted the deformable object 450 (e.g., at the third instance shown in FIGS. 8A and 8B), the continued movement of the arms 420₁, 420₃, and 420₅ toward the deformable object 450 and the continued movement of the arms 420₂, 420₄, and 420₆ toward the deformable object 450 would cause the inclined surfaces 430₃ and 430₄ would exert a lifting force near the middle of the deformable object 450 before the inclined surfaces 430₁, 430₂, 430₅, and 430₆ are in contact with the deformable object 450. The result would be instability of the deformable object 450 as it is lifted by the inclined surfaces 430₃ and 430₄ before being supported by the inclined surfaces 430₁, 430₂, 430₅, and 430₆. In such an unstable lift, the deformable object 450 could teeter and/or fall from the system 400, potentially damaging the deformable object 450 and/or the system 400. In contrast, the coupling of the pairs of opposing arms 420 in the system 400 allows each of the inclined surfaces 430 to be in contact with the deformable object 450 before a significant lifting force is applied by any of the arms 420. Then, when all of the inclined surfaces 430 are in contact with the deformable object 450, all of the inclined surfaces 430 provide a lifting force to reliably and stably lift the deformable object 450 from the surface 452.

Another benefit of the system 400 is that the system can reliably hold the deformable object 450 after the deformable object 450 has been lifted from the surface 452. After the locking mechanisms are in the locked configuration, as they are in the seventh instance shown in FIGS. 12A and 12B, the system 400 can be moved and the fingers 432 will remain locked in the holding position by the locking mechanisms 460. In this way, the system 400 can be moved to move the deformable object. In the eighth instance shown in FIGS. 13A and 13B, the system has been moved away from the surface 452. In some embodiments, the system 400 is coupled to a movement device (e.g., a conveyor, a robotic arm, or any other device capable of movement) that moves the system 400 when the locking mechanisms 460 are in the locked configuration to hold the fingers 432 in the holding position.

Notably, the arms 420 are capable of moving in the inward direction without affecting the configuration of the locking mechanisms 460. In particular, the locking mechanisms 460 were in the locked configuration at the second instance shown in FIGS. 7A and 7B to hold the fingers 432 in the holding position. From the second instance shown in FIGS. 7A and 7B to the seventh instance shown in FIGS. 12A and 12B, the arms 420 were moved inward (e.g., with respect to a frame that holds the arms 420). The inward movement of the arms 420 does not cause the locking mechanisms 460 to transition from the locked configuration to an unlocked configuration. In other words, the locking mechanisms 460 remained in the locked configuration as the arms 420 were moved inward.

At some point, the deformable object 450 will be released from the system 400. In the depicted embodiment, the locking mechanisms 460 are configured to transition from the locked configuration to the unlocked configuration in response to movement of the arms 420 with respect to the frame in the outward direction. In the ninth instance shown in FIGS. 14A and 14B, the arms 420 are being moved outward. For example, the arms 420 are moved outward with respect to the frame by the driving mechanism. The outward movement of the arms 420 causes the locking mechanisms 460 to transition from the locked configuration to the unlocked configuration. Once in the unlocked configuration, the locking mechanisms 460 permit the fingers 432 to rotate downward (i.e., the fingers 432₁, 432₃, and 432₅ rotate counterclockwise when viewing FIG. 14A and the fingers 432₂, 432₄, and 432₆ rotate clockwise when viewing FIG. 14A). The downward rotation of the fingers 432 and/or the outward movement of the arms 420 allows the deformable object 450 to fall from the system 400.

The system 400 can be used to move deformable objects from one location to another. For example, in the method shown in FIGS. 6A to 14B, the surface 452 can represent a conveyor belt in a packaging facility and the position of the system 400 in the ninth instance shown in FIGS. 14A and 14B can be above a shipping box at a boxing station in the packaging facility. In this example, the system 400 can be used to lift the deformable object from the conveyor belt, transport the deformable object to the boxing station, and then drop the deformable object into the shipping box at the boxing station. The use of the locking mechanisms 460 significantly reduces the possibility of the deformable object 450 being dropped by the system 400 while the system is transporting the deformable object 450 between the surface 452 and the position at which the deformable object 450 is intentionally dropped from the system 400.

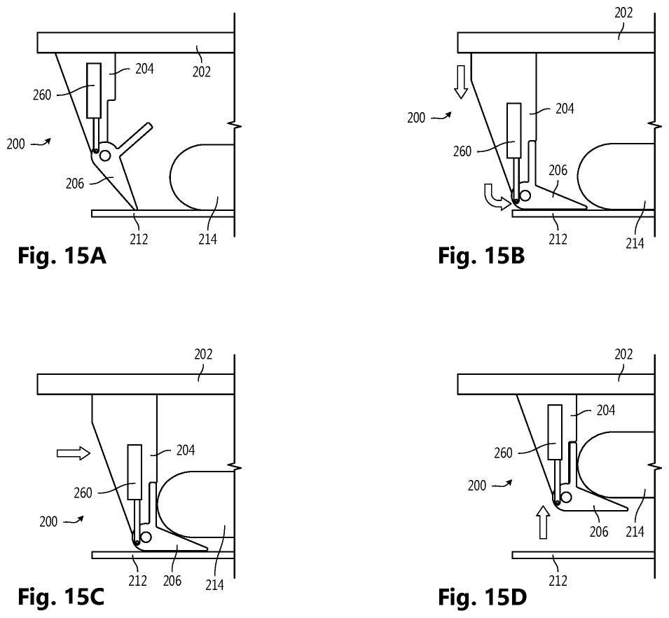

FIGS. 15A to 15D depict instances of another embodiment of a method of using the system 200 to move the deformable object 214. FIG. 15A depicts the same instance shown in FIG. 4A. From the instance shown in FIG. 15A, the arm 204 has been moved downward with respect to the surface 212. The finger 206 contacted the surface 212 such that the surface 212 provided a counterforce on the finger 206 causing the finger 206 to rotate from the open position to the holding position. The locking mechanism 260 is configured to transition from the unlocked configuration to the locked configuration in response to the finger 206 rotating to the holding position. Thus, in FIG. 15B, the locking mechanism 260 is in the locked configuration because the finger 206 has already rotated to the holding position.

From the instance shown in FIG. 15B to the instance shown in FIG. 15C, the arm 204 has moved to the right with respect to the frame 202 until the finger 206 has slid underneath the object 214 and lifted the object from the surface 212. The locking mechanism 260 is configured to transition from the locked configuration to the unlocked configuration in response to movement of the arm 204 with respect to the frame 202 in the outward direction. However, because the arm 204 moved in the inward direction between FIGS. 15B and 15C, the locking mechanism 260 has not transitioned to the unlocked position. From the instance shown in FIG. 15C to the instance shown in FIG. 15D, the arm 204 has been lifted upward with respect to the frame 202. Because the locking mechanism remains in the locked configuration, the finger 206 holds the deformable object 214 as the arm 204 lifts the deformable object 214.

The embodiment of using the system 200 to move the deformable object 214 shown in FIGS. 15A to 15D may be advantageous over the method shown in FIGS. 4A to 4D in a number of circumstances. For example, if the surface 212 has high rigidity and the deformable object 214 has low rigidity and/or is very thin, using the surface to cause the finger 206 to rotate to the holding position may be more reliably and successfully accomplished than using the deformable object 214 to cause the rotation of the finger 206.

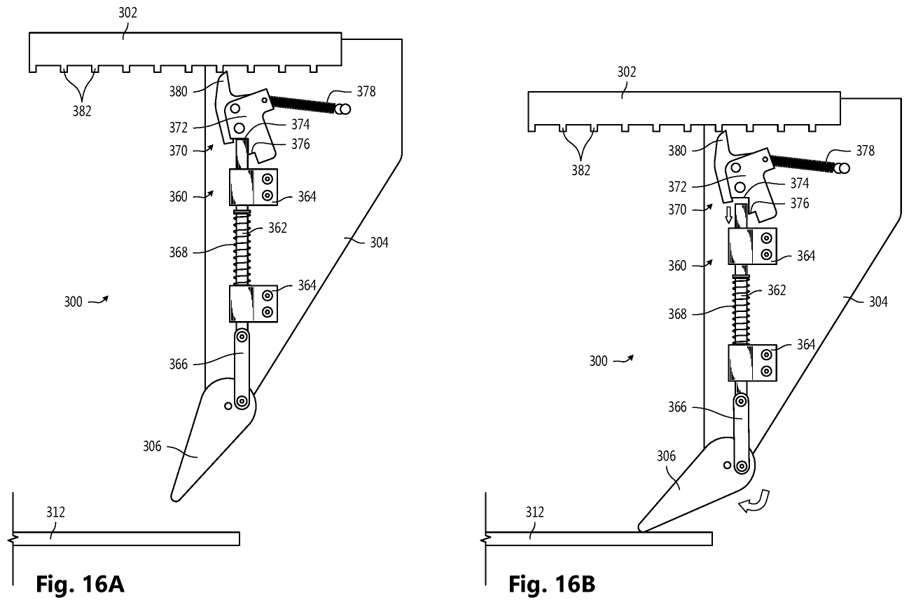

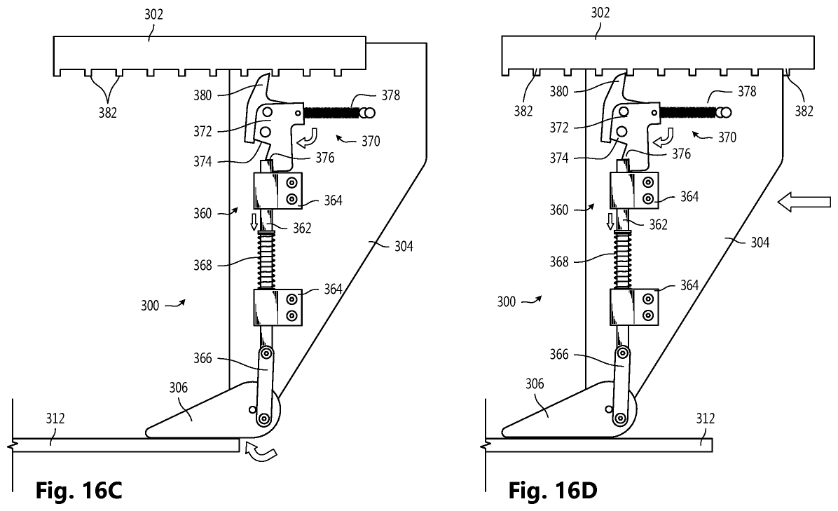

FIGS. 16A to 16D depict instances of another embodiment of the operation of the passive locking mechanism 360 in the system 300. In the particular embodiment shown in FIGS. 16A to 16D, the finger 306 is rotated from the holding position to the locked position due to interaction with a surface 312. In some cases, the surface 312 holds a deformable object that can be lifted and held by the finger 306.

At the instance shown in FIG. 16A, the arm 304 is located with respect to the frame 302 at the same location as shown in FIG. 5A. The system 300 is also shown located above the surface 312. In particular, the finger 306 is located above the surface 312. In FIG. 16A, the finger 306 is in the open position. From the instance shown in FIG. 16A to the instance shown in FIG. 16B, the system 300 has been lowered with respect to the surface 312 until the finger 306 has come into contact with the surface 312. The force exerted by the surface 312 on the finger 306 as the system is lowered has caused the finger 306 to begin rotating from the open position toward the holding position. The rotation of the finger 306 has caused the rod 362 to be pulled downward so that the proximal end of the rod 362 has withdrawn from the first surface 374. However, the locking mechanism 360 has not yet transitioned to the locked configuration because the finger 306 has not reached the holding position.

From the instance shown in FIG. 16B to the instance shown in FIG. 16C, the system 300 has been further lowered with respect to the frame 312. The system 300 has been lowered to the point that the surface 312 has exerted sufficient force on the finger 306 to cause the finger 306 to rotate to the holding position. The rotation of the finger 306 has caused the locking mechanism 360 to transition to the locked configuration. In particular, the rotation of the finger 306 has caused the rod 362 to be withdrawn below the second surface 376 such that the biasing mechanism 378 can cause the head 370 to rotate so that the second surface 374 is located above the proximal end of the rod 362, which will prevent the finger 306 from rotating downward toward the open position.

From the instance shown in FIG. 16C to the instance shown in FIG. 16D, the arm 304 has been moved inward with respect to the frame 302 (i.e., moved to the left when viewing FIGS. 16C and 16D). The inward movement of the arm 304 with respect to the frame 302 does not cause the locking mechanism 360 to transition from the locked configuration to the unlocked configuration. In particular, the pawl 380 is capable of sliding by the teeth 382 when the arm 304 moves with respect to the frame 302 in the inward direction. However, if the arm 304 was moved in the outward direction with respect to the frame 302 (i.e., to the right when viewing FIGS. 16C and 16D), the pawl 380 would catch on the teeth 382 to cause the locking mechanism 360 to transition from the locked configuration to the unlocked configuration, similar to what is depicted and described with respect to FIGS. 5E and 5F.

FIGS. 17A to 17E depicts instances of an embodiment of the rotational movement of the pawl 380 with respect to the body 372 in the locking mechanism 360. In FIG. 17A, the locking mechanism 360 is in the locked configuration and the pawl 380 is between an adjacent pair of the teeth 382 on the frame 302. The pawl 380 is biased counter-clockwise relative to the body 372 by a biasing mechanism 384. In the depicted embodiment, the biasing mechanism 384 is a plunger/spring located in the body 372 that acts on a surface 386 of the pawl 380. The biasing force of the biasing mechanism 384 acts on the surface 386 of the pawl 380 to cause a distal end 388 of the pawl 380 to be in contact with the rest of the body 372.

In FIG. 17B, the locking mechanism 360 remains in the locked configuration while the arm 304 moves inward (i.e., to the left when viewing FIG. 17B) with respect to the frame 302. As the pawl 380 contacts one of the teeth 382, the resulting force on the pawl 380 causes the pawl 380 to rotate around a pivot point against the force of the biasing mechanism 384 in the body 372. This rotation of the pawl 380 allows the pawl 380 to pass under the teeth 382. The pawl 380 will return to the counterclockwise-biased position when the proximal end of the pawl 380 completes passes beyond the tooth due to the force exerted by the biasing mechanism 384 on the pawl 380. The return of the pawl 380 to the counterclockwise-biased position places the pawl 380 in a position that can engage the teeth 382 to transition the locking mechanism 360 to the unlocked configuration when arm 304 moves in the outward direction with respect to the frame 302.

In FIG. 17C, the locking mechanism 360 remains in the locked configuration. The pawl 380 has returned to the counterclockwise-biased with the position proximal end of the pawl 380 located between two of the teeth 382. The arm 304 has started moving in the outward direction until the proximal end of the pawl 380 has come in contact with one of the teeth 382. In this position, the distal end 388 of the pawl 380 is in contact with the body 372 such that the pawl 380 cannot rotate further in the counterclockwise direction unless the body 372 also rotates in the counterclockwise direction with the pawl 380.

In FIG. 17D, the arm 304 has continued moving in the outward direction with respect to the frame 302. The pawl 380 is in contact with one of the teeth 382, which exerts a force on the proximal end of the pawl 380. The force exerted on the pawl 380 is able to rotate the pawl 380 and the body 372 together against the force of the biasing mechanism 378. This rotation of the body 372 has caused the second surface 376 to rotate beyond the proximal end of the rod 362 so that the rod can move upward toward the first surface 374. This results in the locking mechanism 360 transitioning to the unlocked configuration to permit rotation of the finger 306. In some embodiments, the geometry of the pawl 380 and/or the body 372 is arranged so that the locking mechanism 360 transitions to the unlocked configuration before the pawl 380 completely passes under the tooth.

In FIG. 17E, the rod 362 has moved upward toward the first surface 374 to cause the locking mechanism 360 to be in the unlocked configuration. The pawl 380 has rotated sufficiently that the pawl 382 can pass under the tooth. This position of the pawl 380 allows continued movement of the arm 304 with respect to the frame 302 in the outward direction. The pawl 380 will likewise be able to pass under any of the other teeth 382 as the arm 304 continues to move in the outward direction with respect to the frame 302.

The embodiments of locking mechanisms described herein allow for the systems to be used with deformable objects in a wide variety of shapes and sizes. In particular, by transitioning to the locked configuration in response to rotation of the finger to the holding position and by transition to the unlocked configuration in response to movement of the arm in a particular direction with respect to the frame, the system with the locking mechanism can allow the system to work any nearly any size and shape of object. In particular, the locking mechanism will hold the finger in the holding position when the finger rotates to the holding position and will release the finger when the arm moves in the particular direction. These actions are performed regardless of size or shape of the object that is interacting with the finger. In addition, with the embodiments of passive locking mechanisms described herein, these actions occur automatically based on rotation of the finger and movement of the arm without the need for sensors, controllers, and other elements that make up an active system.

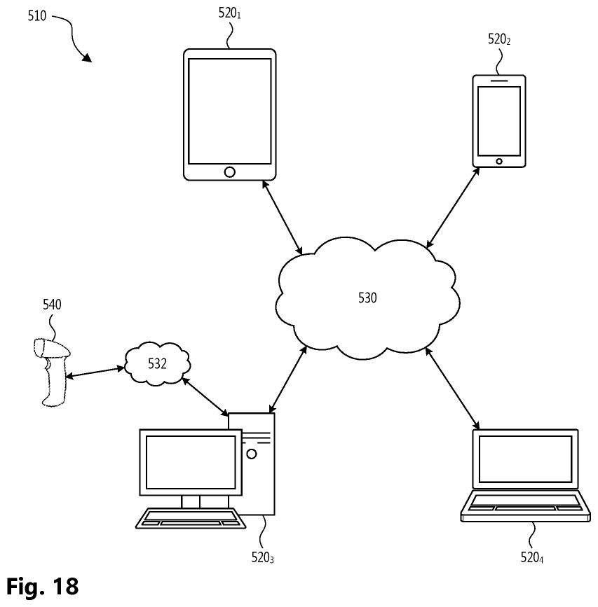

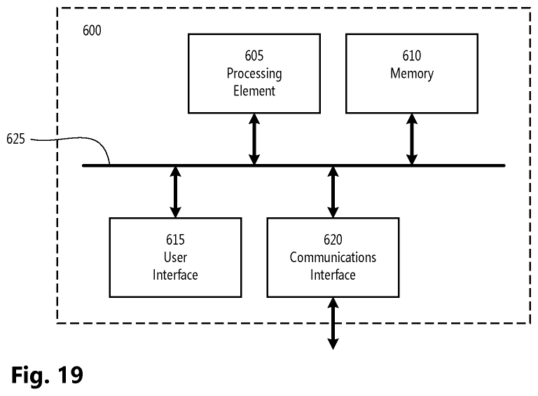

FIG. 18 depicts an example embodiment of a system 510 that may be used to implement some or all of the embodiments described herein. In the depicted embodiment, the system 510 includes computing devices 520₁, 520₂, 520₃, and 520₄ (collectively computing devices 520). In the depicted embodiment, the computing device 520₁ is a tablet, the computing device 520₂ is a mobile phone, the computing device 520₃ is a desktop computer, and the computing device 520₄ is a laptop computer. In other embodiments, the computing devices 520 include one or more of a desktop computer, a mobile phone, a tablet, a phablet, a notebook computer, a laptop computer, a distributed system, a gaming console (e.g., Xbox, Play Station, Wii), a watch, a pair of glasses, a key fob, a radio frequency identification (RFID) tag, an ear piece, a scanner, a television, a dongle, a camera, a wristband, a wearable item, a kiosk, an input terminal, a server, a server network, a blade, a gateway, a switch, a processing device, a processing entity, a set-top box, a relay, a router, a network access point, a base station, any other device configured to perform the functions, operations, and/or processes described herein, or any combination thereof.

The computing devices 520 are communicatively coupled to each other via one or more networks 530 and 532. Each of the networks 530 and 532 may include one or more wired or wireless networks (e.g., a 3G network, the Internet, an internal network, a proprietary network, a secured network). The computing devices 520 are capable of communicating with each other and/or any other computing devices via one or more wired or wireless networks. While the particular system 510 in FIG. 18 depicts that the computing devices 520 communicatively coupled via the network 530 include four computing devices, any number of computing devices may be communicatively coupled via the network 530.

In the depicted embodiment, the computing device 5203 is communicatively coupled with a peripheral device 540 via the network 532. In the depicted embodiment, the peripheral device 540 is a scanner, such as a barcode scanner, an optical scanner, a computer vision device, and the like. In some embodiments, the network 532 is a wired network (e.g., a direct wired connection between the peripheral device 540 and the computing device 520₃), a wireless network (e.g., a Bluetooth connection or a WiFi connection), or a combination of wired and wireless networks (e.g., a Bluetooth connection between the peripheral device 540 and a cradle of the peripheral device 540 and a wired connection between the peripheral device 540 and the computing device 520₃). In some embodiments, the peripheral device 540 is itself a computing device (sometimes called a “smart” device). In other embodiments, the peripheral device 540 is not a computing device (sometimes called a “dumb” device).

Depicted in FIG. 19 is a block diagram of an embodiment of a computing device 600. Any of the computing devices 520 and/or any other computing device described herein may include some or all of the components and features of the computing device 600. In some embodiments, the computing device 600 is one or more of a desktop computer, a mobile phone, a tablet, a phablet, a notebook computer, a laptop computer, a distributed system, a gaming console (e.g., an Xbox, a Play Station, a Wii), a watch, a pair of glasses, a key fob, a radio frequency identification (RFID) tag, an ear piece, a scanner, a television, a dongle, a camera, a wristband, a wearable item, a kiosk, an input terminal, a server, a server network, a blade, a gateway, a switch, a processing device, a processing entity, a set-top box, a relay, a router, a network access point, a base station, any other device configured to perform the functions, operations, and/or processes described herein, or any combination thereof. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein.

In the depicted embodiment, the computing device 600 includes a processing element 605, memory 610, a user interface 615, and a communications interface 620. The processing element 605, memory 610, a user interface 615, and a communications interface 620 are capable of communicating via a communication bus 625 by reading data from and/or writing data to the communication bus 625. The computing device 600 may include other components that are capable of communicating via the communication bus 625. In other embodiments, the computing device does not include the communication bus 625 and the components of the computing device 600 are capable of communicating with each other in some other way.

The processing element 605 (also referred to as one or more processors, processing circuitry, and/or similar terms used herein) is capable of performing operations on some external data source. For example, the processing element may perform operations on data in the memory 610, data receives via the user interface 615, and/or data received via the communications interface 620. As will be understood, the processing element 605 may be embodied in a number of different ways. In some embodiments, the processing element 605 includes one or more complex programmable logic devices (CPLDs), microprocessors, multi-core processors, co processing entities, application-specific instruction-set processors (ASIPs), microcontrollers, controllers, integrated circuits, application specific integrated circuits (ASICs), field programmable gate arrays (FPGAs), programmable logic arrays (PLAs), hardware accelerators, any other circuitry, or any combination thereof. The term circuitry may refer to an entirely hardware embodiment or a combination of hardware and computer program products. In some embodiments, the processing element 605 is configured for a particular use or configured to execute instructions stored in volatile or nonvolatile media or otherwise accessible to the processing element 605. As such, whether configured by hardware or computer program products, or by a combination thereof, the processing element 605 may be capable of performing steps or operations when configured accordingly.

The memory 610 in the computing device 600 is configured to store data, computer-executable instructions, and/or any other information. In some embodiments, the memory 610 includes volatile memory (also referred to as volatile storage, volatile media, volatile memory circuitry, and the like), non-volatile memory (also referred to as non-volatile storage, non-volatile media, non-volatile memory circuitry, and the like), or some combination thereof.

In some embodiments, volatile memory includes one or more of random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, any other memory that requires power to store information, or any combination thereof.

In some embodiments, non-volatile memory includes one or more of hard disks, floppy disks, flexible disks, solid-state storage (SSS) (e.g., a solid state drive (SSD)), solid state cards (SSC), solid state modules (SSM), enterprise flash drives, magnetic tapes, any other non-transitory magnetic media, compact disc read only memory (CD ROM), compact disc-rewritable (CD-RW), digital versatile disc (DVD), Blu-ray disc (BD), any other non-transitory optical media, read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, Memory Sticks, conductive-bridging random access memory (CBRAM), phase-change random access memory (PRAM), ferroelectric random-access memory (FeRAM), non-volatile random access memory (NVRAM), magneto-resistive random access memory (MRAM), resistive random-access memory (RRAM), Silicon Oxide-Nitride-Oxide-Silicon memory (SONOS), floating junction gate random access memory (FJG RAM), Millipede memory, racetrack memory, any other memory that does not require power to store information, or any combination thereof.

In some embodiments, memory 610 is capable of storing one or more of databases, database instances, database management systems, data, applications, programs, program modules, scripts, source code, object code, byte code, compiled code, interpreted code, machine code, executable instructions, or any other information. The term database, database instance, database management system, and/or similar terms used herein may refer to a collection of records or data that is stored in a computer-readable storage medium using one or more database models, such as a hierarchical database model, network model, relational model, entity relationship model, object model, document model, semantic model, graph model, or any other model.

The user interface 615 of the computing device 600 is in communication with one or more input or output devices that are capable of receiving inputs into and/or outputting any outputs from the computing device 600. Embodiments of input devices include a keyboard, a mouse, a touchscreen display, a touch sensitive pad, a motion input device, movement input device, an audio input, a pointing device input, a joystick input, a keypad input, peripheral device 540, foot switch, and the like. Embodiments of output devices include an audio output device, a video output, a display device, a motion output device, a movement output device, a printing device, and the like. In some embodiments, the user interface 615 includes hardware that is configured to communicate with one or more input devices and/or output devices via wired and/or wireless connections.

The communications interface 620 is capable of communicating with various computing devices and/or networks. In some embodiments, the communications interface 620 is capable of communicating data, content, and/or any other information, that can be transmitted, received, operated on, processed, displayed, stored, and the like. Communication via the communications interface 620 may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, communication via the communications interface 620 may be executed using a wireless data transmission protocol, such as general packet radio service (GPRS), Universal Mobile Telecommunications System (UMTS), Code Division Multiple Access 2000 (CDMA2000), CDMA2000 4X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (WiFi), WiFi Direct, 802.16 (WiMAX), ultra wideband (UWB), infrared (IR) protocols, near field communication (NFC) protocols, Wibree, Bluetooth protocols, wireless universal serial bus (USB) protocols, or any other wireless protocol.

As will be appreciated by those skilled in the art, one or more components of the computing device 600 may be located remotely from other components of the computing device 600 components, such as in a distributed system. Furthermore, one or more of the components may be combined and additional components performing functions described herein may be included in the computing device 600. Thus, the computing device 600 can be adapted to accommodate a variety of needs and circumstances. The depicted and described architectures and descriptions are provided for exemplary purposes only and are not limiting to the various embodiments described herein.

Embodiments described herein may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

As should be appreciated, various embodiments of the embodiments described herein may also be implemented as methods, apparatus, systems, computing devices, and the like. As such, embodiments described herein may take the form of an apparatus, system, computing device, and the like executing instructions stored on a computer readable storage medium to perform certain steps or operations. Thus, embodiments described herein may be implemented entirely in hardware, entirely in a computer program product, or in an embodiment that comprises combination of computer program products and hardware performing certain steps or operations.

Embodiments described herein may be made with reference to block diagrams and flowchart illustrations. Thus, it should be understood that blocks of a block diagram and flowchart illustrations may be implemented in the form of a computer program product, in an entirely hardware embodiment, in a combination of hardware and computer program products, or in apparatus, systems, computing devices, and the like carrying out instructions, operations, or steps. Such instructions, operations, or steps may be stored on a computer readable storage medium for execution buy a processing element in a computing device. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

What is claimed is:

1. A system comprising:
a frame;
an arm movable with respect to the frame in a first direction and in a second direction opposite to the first direction;
a finger rotatably coupled to the arm, wherein the finger is rotatable with respect to the arm between an open position and a holding position; and
a locking mechanism coupled to the finger, wherein the locking mechanism is configured to selectively be in an unlocked configuration and in a locked configuration, wherein the locking mechanism is configured to:
allow the finger to rotate between the open position and the holding position when the locking mechanism is in the unlocked configuration,
transition from the unlocked configuration to the locked configuration in response to the finger rotating to the holding position,
hold the finger in the holding position when the locking mechanism is in the locked configuration, and
transition from the locked configuration to the unlocked configuration in response to movement of the arm with respect to the frame in the second direction.

2. The system of claim 1, wherein the locking mechanism is a passive locking mechanism.

3. The system of claim 2, wherein the passive locking mechanism comprises:
a rod slidably coupled to the arm; and
a head rotatably coupled to the arm;
wherein the rod includes a distal end coupled to the finger and a proximal end configured to engage the head.

4. The system of claim 3, wherein the head comprises a first surface and a second surface, wherein the head and the rod are arranged so that:
the proximal end of the rod is capable of contacting the first surface when the locking mechanism is in the unlocked configuration; and
the proximal end of the rod contacts the second surface when the locking mechanism is in the locked configuration.

5. The system of claim 4, wherein the passive locking mechanism includes a first biasing mechanism configured to bias the rod toward the head.

6. The system of claim 5, wherein the passive locking mechanism includes a second biasing mechanism configured to rotationally bias the head to the locked configuration with the second surface located above the proximal end of the rod.

7. The system of claim 6, wherein:
the head comprises a pawl;
the frame comprises a plurality of teeth;
when the locking mechanism is in the locked configuration and the arm is with respect to the frame in the second direction, the pawl is positioned to engage one of the plurality of teeth to rotate the head against a force of the second biasing mechanism.

8. The system of claim 7, wherein a spacing between each of the plurality of teeth is less than or equal to 0.75 inches (1.91 cm).

9. The system of claim 7, wherein the pawl is rotationally biased with respect to a body of the head.

10. The system of claim 1, wherein the locking mechanism is an active locking mechanism.

11. The system of claim 10, wherein the active locking mechanism comprises a controller configured to:
control transition of the locking mechanism from the unlocked configuration to the locked configuration in response to the finger rotating to the holding position; and
control the transition of the locking mechanism from the locked configuration to the unlocked configuration in response to movement of the arm with respect to the frame in the second direction.

12. The system of claim 11, wherein the active locking mechanism further comprises one or more sensor configured to detect at least one of:
rotation of the finger to the holding position; or
movement of the arm with respect to the frame in the second direction.

13. A system comprising:
a frame;
a first pair of opposing arms, wherein the first pair of opposing arms includes a first arm and a second arm, and wherein each of the first and second arms is movable with respect to the frame in an inward direction toward the other of the first and second arms and in an outward direction away from the other of the first and second arms;
a first finger rotatably coupled to the first arm and a second finger rotatably coupled to the second arm, wherein each of the first and second fingers is rotatable between an open position and a holding position; and
a first locking mechanism coupled to the first finger and a second locking mechanism coupled to the second finger, wherein each of the first and second locking mechanisms is configured to selectively be in an unlocked configuration and in a locked configuration;
wherein the first locking mechanism is configured to:
allow the first finger to rotate between the open position and the holding position when the first locking mechanism is in the unlocked configuration,
transition from the unlocked configuration to the locked configuration in response to the first finger rotating to the holding position,
hold the first finger in the holding position when the locking mechanism is in the locked configuration, and
transition from the locked configuration to the unlocked configuration in response to movement of the first arm with respect to the frame in the outward direction; and
wherein the second locking mechanism is configured to:
allow the second finger to rotate between the open position and the holding position when the second locking mechanism is in the unlocked configuration,
transition from the unlocked configuration to the locked configuration in response to the second finger rotating to the holding position,
hold the second finger in the holding position when the locking mechanism is in the locked configuration, and
transition from the locked configuration to the unlocked configuration in response to movement of the second arm with respect to the frame in the outward direction.

14. The system of claim 13, wherein the first and second arms are biased away from each other by a biasing force.

15. The system of claim 14, wherein the frame is configured to exert a force on the first and second arms to cause the first and second arms to move inward with respect to the frame against the biasing force.

16. The system of claim 13, wherein the each of the first and second locking mechanisms is a passive locking mechanism that comprises:
a rod slidably coupled to one of the first and second arms; and
a head rotatably coupled to the one of the first and second arms;
wherein the rod includes a distal end coupled to the finger and a proximal end configured to engage the head;
wherein the head comprises a pawl;
wherein the frame comprises a plurality of teeth; and
wherein, when the locking mechanism is in the locked configuration and the arm is with respect to the frame in the second direction, the pawl is positioned to engage one of the plurality of teeth to rotate the head.

17. The system of claim 13, further comprising:
a second pair of opposing arms, wherein the second pair of opposing arms includes a third arm and a fourth arm, and wherein each of the third and fourth arms is movable with respect to the frame in an inward direction toward the other of the third and fourth arms and in an outward direction away from the other of the third and fourth arms;
a third finger rotatably coupled to the third arm and a fourth finger rotatably coupled to the fourth arm, wherein each of the third and fourth fingers is rotatable between an open position and a holding position; and
a third locking mechanism coupled to the third finger and a fourth locking mechanism coupled to the fourth finger, wherein each of the third and fourth locking mechanisms is configured to selectively be in an unlocked configuration and in a locked configuration;
wherein the third locking mechanism is configured to:
allow the third finger to rotate between the open position and the holding position when the third locking mechanism is in the unlocked configuration,
transition from the unlocked configuration to the locked configuration in response to the third finger rotating to the holding position,
hold the third finger in the holding position when the locking mechanism is in the locked configuration, and
transition from the locked configuration to the unlocked configuration in response to movement of the third arm with respect to the frame in the outward direction; and
wherein the fourth locking mechanism is configured to:
allow the fourth finger to rotate between the open position and the holding position when the fourth locking mechanism is in the unlocked configuration,
transition from the unlocked configuration to the locked configuration in response to the fourth finger rotating to the holding position,
hold the fourth finger in the holding position when the locking mechanism is in the locked configuration, and
transition from the locked configuration to the unlocked configuration in response to movement of the fourth arm with respect to the frame in the outward direction.

18. The system of claim 17, wherein the first pair of opposing arms is capable of inward and outward movement independently of inward and outward movement of the second pair of opposing arms.

19. The system of claim 17, further comprising:
a third pair of opposing arms, wherein the third pair of opposing arms includes a fifth arm and a sixth arm, and wherein each of the fifth and sixth arms is movable with respect to the frame in an inward direction toward the other of the fifth and sixth arms and in an outward direction away from the other of the fifth and sixth arms;
a fifth finger rotatably coupled to the fifth arm and a sixth finger rotatably coupled to the sixth arm, wherein each of the fifth and sixth fingers is rotatable between an open position and a holding position; and
a fifth locking mechanism coupled to the fifth finger and a sixth locking mechanism coupled to the sixth finger, wherein each of the fifth and sixth locking mechanisms is configured to selectively be in an unlocked configuration and in a locked configuration;
wherein the fifth locking mechanism is configured to:
allow the fifth finger to rotate between the open position and the holding position when the fifth locking mechanism is in the unlocked configuration,
transition from the unlocked configuration to the locked configuration in response to the fifth finger rotating to the holding position,
hold the fifth finger in the holding position when the locking mechanism is in the locked configuration, and
transition from the locked configuration to the unlocked configuration in response to movement of the fifth arm with respect to the frame in the outward direction; and
wherein the sixth locking mechanism is configured to:
allow the sixth finger to rotate between the open position and the holding position when the sixth locking mechanism is in the unlocked configuration,
transition from the unlocked configuration to the locked configuration in response to the sixth finger rotating to the holding position,
hold the sixth finger in the holding position when the locking mechanism is in the locked configuration, and
transition from the locked configuration to the unlocked configuration in response to movement of the sixth arm with respect to the frame in the outward direction.

20. The system of claim 19, wherein each of the first pair of opposing arms, the second pair of opposing arms, and the third pair of opposing arms is capable of inward and outward movement independently of the others of the first pair of opposing arms, the second pair of opposing arms, and the third pair of opposing arms.
